(19) United States
(12) Patent Application Publication
(10) Pub. No.: US 2022/0256632 A1
(43) Pub. Date: Aug. 11, 2022

(54) METHOD AND COMMUNICATION NETWORK FOR PROVIDING ACCESS TO LOCALIZED SERVICES (PALS)

(71) Applicant: Samsung Electronics Co., Ltd., Suwon-si (KR)

(72) Inventors: Vinay Kumar SHRIVASTAVA, Bangalore (IN); Diwakar SHARMA, Bangalore (IN); Varini GUPTA, Bangalore (IN); Erik Arthur GUTTMAN, Staines (GB)

(21) Appl. No.: 17/667,466

(22) Filed: Feb. 8, 2022

(30) Foreign Application Priority Data
Feb. 8, 2021 (IN) 202141005326
Jan. 20, 2022 (IN) 202141005326

(51) Int. Cl. H04W 76/15; H04W 76/28; H04W 68/00; H04W 24/08

(52) U.S. Cl. CPC H04W 76/15; H04W 24/08; H04W 68/005; H04W 76/28

(57) ABSTRACT

The disclosure relates to a 5G or 6G communication system for supporting a higher data transmission rate. Embodiments herein provide a method for PALS in a communication network by a UE. The method comprises: establishing a connection with a host network apparatus of the communication network; establishing a connection with a home network apparatus of the communication network; selecting at least one of the home network apparatus or the host network apparatus to access at least one of a multicast service delivery mode, a unicast service delivery mode, or a broadcast service delivery mode based on service prioritization at the UE; and receiving content disseminated from the at least one of the home network apparatus or the host network apparatus over the at least one of the multicast service delivery mode, the unicast service delivery mode, or the broadcast service delivery mode in the communication network.

### CROSS-REFERENCE TO RELATED APPLICATIONS

This application is based on and claims priority under 35 U.S.C. § 119(a) of an Indian Provisional patent application number 202141005326 filed on Feb. 8, 2021, in the Indian Patent Office, and of an Indian Non-Provisional patent application number 202141005326, filed on Jan. 20, 2022, in the Indian Patent Office, the disclosures of which are incorporated by reference herein in their entirety.

### BACKGROUND

### 1. Field

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

### 2. Description of Related Art

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

The principal object of the embodiments herein is to provide a method and a system for PALS in a communication network.

Yet another object of the embodiments herein is to provide multicast and/or broadcast requirements and potential approaches for PALS networks that include:
a) Efficient paging approaches to cater large user base and avoid false paging;
b) Scale up and achieve differential treatment (e.g., low latency) with RACH partitioning, pooling, and prioritization approaches;
c) Achieve energy efficiency with paging/measurement and operation of multicast in idle state; and
d) Service continuity and service prioritization across host and home networks.

Accordingly, the embodiment herein is to provide a method for PALS in a communication network. The method includes establishing, by a UE, a communication connection with a host network apparatus of the communication network. Further, the method includes establishing, by the UE, a communication connection with a home network apparatus of the communication network. Further, the method includes selecting, by the UE, at least one of the home network apparatus or the host network apparatus to access at least one of a multicast service delivery mode, a unicast service delivery mode, or a broadcast service delivery mode based on service prioritization at the UE. Further, the method includes receiving, by the UE, content disseminated from at least one of the home network apparatus or the host network apparatus over at least one of the multicast service delivery mode, the unicast service delivery mode, or the broadcast service delivery mode in the communication network using the selected network from the home network apparatus and the host network apparatus.

In an embodiment, further, the method includes receiving, by the UE, a UE capability request from at least one of the home network apparatus or the host network apparatus. further, the method includes sending, by the UE, a UE capability response comprising support for the multiple Tx-Rx to at least one of the host network apparatus or the host network apparatus, wherein the UE supports multiple transmission (TX) antennas and multiple reception (RX) antennas and operates in one of carrier aggregation mode with the host network apparatus and the home network apparatus or a dual connectivity mode with the host network apparatus and the home network apparatus.

In an embodiment, selecting, by the UE, one of the home network apparatus and the host network apparatus to access at least one of the multicast service delivery mode, the unicast service delivery mode, or the broadcast service delivery mode based on service prioritization at the UE includes determining, by the UE, a plurality of parameters associated with the home network apparatus, wherein the plurality of parameters associated with the home network apparatus comprises a home network link status, home network measurements, and a home network service availability, determining, by the UE, a plurality of parameters associated with the host network apparatus, wherein the plurality of parameters associated with the host network apparatus comprises a host network link status, host network measurements, and a host network service availability, prioritizing, by the UE, service from the host network apparatus and the home network apparatus based on the plurality of parameters associated with the home network apparatus and the plurality of parameters associated with the host network apparatus, and selecting, by the UE, one of the home network apparatus and the host network apparatus to access at least one of the multicast service delivery mode, the unicast service delivery mode, or the broadcast service delivery mode based on the service prioritization at the UE.

In an embodiment, receiving, by the UE, content disseminated from at least one of the home network apparatus or the host network apparatus over at least one of the multicast service delivery mode, the unicast service delivery mode, or the broadcast service delivery mode in the communication network using the selected network includes receiving, by the UE, discontinuous reception (DRX) parameters from one of the home network apparatus and the host network apparatus in order to align a connected mode DRX at the UE to the host network apparatus and a connected mode DRX at the UE to the home network apparatus, wherein the DRX parameters comprises at least one of a DRX cycle length, a DRX ON duration timer, a short DRX cycle, a long DRX cycle, a DRX retransmission timer, DRX round trip time (RTT) timers, or a DRX offset, and receiving, by the UE, the content disseminated from the home network apparatus and the host network apparatus over at least one of the multicast service delivery mode, the unicast service delivery mode, or the broadcast service delivery mode based on the alignment of the connected mode DRX at the UE to the host network apparatus and a connected mode DRX at the UE to the home network apparatus.

In an embodiment, receiving, by the UE, content disseminated from at least one of the home network apparatus or the host network apparatus over at least one of the multicast service delivery mode, the unicast service delivery mode, or the broadcast service delivery mode in the communication network using the selected network includes receiving, by the UE, a caching willingness enquiry message from the host network, determining, by the UE, whether to receive and cache content at the UE based on at least one of a popularity matrix, a battery status of the UE, or a storage capacity of the UE, sending, by the UE, a caching willingness response indicating for willingness of the UE to receive and cache the content from the host network apparatus. receive the content from the host network, and receiving, by the UE, the content from the host network over at least one of the multicast service delivery mode, the unicast service delivery mode, or the broadcast service delivery mode.

In an embodiment, the method includes splitting, by the UE, the content received from the host network into at least one of the multicast service delivery mode, the unicast service delivery mode, or the broadcast service delivery mode. Further, the method includes sending by the UE the content received from the host network to at least one other UE over at least one of the multicast service delivery mode, the unicast service delivery mode, or the broadcast service delivery mode using a radio link or a side link.

In an embodiment, the method includes determining, by the UE, misalignment of the paging occasion and multicast or broadcast service scheduling occasions. Further, the method includes sending, by the UE, a globally unique temporary identifier (GUTI) reassignment request to the host network apparatus, wherein the GUTI reassignment request is sent to ensure alignment of idle mode DRX cycle of the host network apparatus and the home network apparatus. Further, the method includes receiving, by the UE, a new paging resources information from the host network, wherein the new paging resources information comprises at least one of a paging offset or a UE identity.

In an embodiment, the method includes receiving, by the UE, paging configuration information including paging sub-group in order to receive a paging for specific multicast or broadcast service delivery modes associated with the sub-group. Further, the method includes receiving, by the UE, a paging early indication (PEI) before the paging occasion indicating presence or absence of the sub-group paging for the UE for specific multicast or broadcast service delivery modes associated with the subgroup.

In an embodiment, the method includes receiving, by the UE, a wakeup signal from one of the home network apparatus and the host network apparatus with an offset before scheduling of traffic from one of the home network apparatus and the host network apparatus to leverage the UE for at least one of multicast service delivery mode allocation, the unicast service delivery mode allocation, or the broadcast service delivery mode allocation. Further, the method includes monitoring and receiving allocation of at least one of multicast data, unicast data, or broadcast data based on determination of presence of allocation from the wakeup signal. Further, the method includes performing sleep operation based on determination of absence of allocation from the wakeup signal.

In an embodiment, the method includes performing, by the UE, a reference signal measurement when the UE is in point to multi-point in idle mode (PTM_Idle) and has subscribed for at least one of the multicast service delivery mode, the unicast service delivery mode, or the broadcast service delivery mode. Further, the method includes determining, by the UE, whether the reference signal measurement meets a reference signal threshold. Further, the method includes sending, by the UE, a feedback comprising the reference signal measurements to the host network apparatus in response to determining that the reference signal measurement meets the reference signal threshold, wherein the feedback is sent through one of a random access channel (RACH) message, an idle mode measurement message and a RRC message. Further, the method includes receiving, by the UE, a RRC configuration from the host network to configure the UE in one of a Point to multipoint in connected (PTM_conn) mode and a Point to point connected (PTP_conn) mode.

In an embodiment, the method includes measuring, by the UE, at least one of a beam index (BI), a channel quality indicator (CQI), a precoding matrix indicator (PMI), or a rank indicator (RI) when the UE is in one of the PTM_conn mode and the PTP_conn mode. Further, the method includes sending, by the UE, a channel state information (CSI) feedback to the host network. The method includes receiving, by the UE, a RRC configuration from the host network to reconfigure the UE to one of the PTM_conn mode, the PTP_conn mode and the PTM_idle mode.

In an embodiment, sending, by the UE, a feedback comprising the reference signal measurements to the host network includes configuring, by the host network apparatus (200), a RACH configuration by dividing RACH resources into subgroups, wherein physical resources in each of the subgroup is used to send feedback for a specific multicast and broadcast service delivery modes; and sending, by the UE, the feedback using the RACH message.

In an embodiment, the method includes determining, by the UE, a need to transit to one of an idle mode or an inactive mode based on power saving need of the UE, a link condition between the UE and the host network apparatus. Further, the method includes signaling, by the UE, an indication or a preference to the host network apparatus for the transition to the idle mode or the inactive mode.

In an embodiment, the method includes receiving, by the UE, signaling from the host network apparatus for the configuration and transition of the UE to one of an idle mode or an inactive mode. Further, the method includes transitioning, by the UE, to one of the idle mode or the inactive mode. Further, the method includes continuing, by the UE, reception of contents from the host network apparatus in one of the idle mode or the inactive mode.

Accordingly, the embodiment herein is to provide a method for PALS in a communication network. The method includes establishing, by a host network apparatus of the communication network, a communication connection with at least one UE from a plurality of UEs in the communication network. Further, the method includes enabling, by the host network apparatus of the communication network, for allowing different local service providers and content providers in the communication network to disseminate services and content over one of broadcast, multicast and unicast transport to the at least one UE in the communication network. Further, the method includes disseminating, the host network apparatus, the content to the at least one UE over at least one of a multicast service delivery mode, a unicast service delivery mode, or a broadcast service delivery mode to the at least one UE in the communication network.

In an embodiment, further, the method includes receiving, by the host network apparatus, a plurality of requests from the plurality of UEs. Further, the method includes determining, by the host network apparatus, whether the plurality of requests is greater than, less than or equal to a user request density threshold. Further, the method includes performing, by the host network apparatus, at least one of: configuring one of the multicast service delivery mode or the broadcast service delivery mode to disseminate the content to the at least one UE in response to determining that the plurality of requests is greater than or equal to the user request density threshold, and configuring the unicast service delivery mode to disseminate the content to the at least one UE in response to determining that the plurality of requests is less than the user request density threshold.

In an embodiment, disseminating, the host network apparatus, the content to the at least one UE over at least one of the multicast service delivery mode, the unicast service delivery mode, or the broadcast service delivery mode to the at least one UE in the communication network includes receiving, by the host network apparatus, home network content to be shared to the at least one UE from the home network apparatus, splitting, by the host network apparatus, the home network content into at least one of the multicast service delivery mode, the unicast service delivery mode, or the broadcast service delivery mode, and disseminating, by the host network apparatus, the home network content over at least one of the multicast service delivery mode, the unicast service delivery mode, or the broadcast service delivery mode to the at least one UE.

In an embodiment, disseminating, the host network apparatus, the content to the at least one UE over at least one of the multicast service delivery mode, the unicast service delivery mode, or the broadcast service delivery mode to the at least one UE in the communication network includes receiving, by the host network apparatus, home network content to be shared to the at least one UE from the home network apparatus, stitching, by the host network apparatus, the home network content with host network content, receiving, by the host network apparatus, home network content to be routed by host network, and disseminating, by the host network apparatus, the home network content stitched with the host network content over at least one of the multicast service delivery mode, the unicast service delivery mode, or the broadcast service delivery mode to the at least one UE.

In an embodiment, disseminating, the host network apparatus, the content to the at least one UE over at least one of the multicast service delivery mode, the unicast service delivery mode, or the broadcast service delivery mode to the at least one UE in the communication network includes caching, by the host network apparatus, the content based on a popularity matrix. sending, by the host network apparatus, a caching willingness enquiry message to the at least one UE, receiving, by the host network apparatus, a caching willingness response indicating caching willingness of the UE to receive and cache the content from the host network, splitting, by the host network apparatus, the content into at least one of the multicast service delivery mode, the unicast service delivery mode, or the broadcast service delivery mode, and disseminating, by the host network apparatus, the home network content over at least one of the multicast service delivery mode, the unicast service delivery mode, or the broadcast service delivery mode to the at least one UE.

In an embodiment, the method includes receiving, by the host network apparatus, a GUTI reassignment request from the at least one UE, wherein the GUTI reassignment request is sent to ensure alignment of idle mode DRX cycle of the host network apparatus and the home network apparatus, receiving, by the host network apparatus, a home network paging resources information from the home network paging apparatus, and sending, by the host network apparatus, the home network paging resources information to the at least one UE to receive the content over at least one of the multicast service delivery mode, the unicast service delivery mode, or the broadcast service delivery mode to align the idle mode DRX cycle of the host and home network apparatus, wherein the new paging resources information comprises at least one of a paging offset or a UE identity.

In an embodiment, the method includes dividing, by the host network apparatus, paging resources into subgroups. Further, the method includes sending, by the host network apparatus, a paging configuration information to the at least one UE, wherein paging configuration information includes the paging sub-group in order to receive a paging for specific multicast or broadcast service delivery modes associated with the sub-group. Further, the method includes sending, by the host network apparatus, a paging early indication (PEI) to the at least one UE before the paging occasion indicating presence or absence of the sub-group paging for the UE for specific multicast or broadcast service delivery modes associated with the subgroup.

In an embodiment, the method includes sending, by the host network apparatus, a wakeup signal to the at least one UE an offset before scheduling of traffic from one of the home network apparatus and the host network apparatus to leverage the UE for at least one of multicast service delivery mode allocation, the unicast service delivery mode allocation, or the broadcast service delivery mode allocation. Further, the method includes scheduling, by the host network apparatus, of at least one of multicast data, unicast data, or broadcast data to the UE when presence of allocation is indicated in the wakeup signal to the UE. Further, the method includes skipping, by the host network apparatus, scheduling of at least one of multicast data, unicast data, or broadcast data to the UE when absence of allocation is indicated in the wakeup signal to the UE.

In an embodiment, the method includes receiving, by the host network apparatus, a feedback comprising the reference signal measurements from the at least one UE, wherein the feedback is received through one of a RACH message, an idle mode measurement message and a RRC message. Further, the method includes switching, by the host network apparatus, from Point to multipoint idle (PTM_idle) to the one of Point to multipoint connected (PTM_conn) mode and a Point to point connected (PTP_conn) mode. Further, the method includes sending, by the host network apparatus, a RRC configuration from the host network to configure the UE in one of the PTM_conn mode and the PTP_conn mode. Further, the method includes receiving, by the host network apparatus, a CSI feedback from the at least one UE. Further, the method includes switching, by the host network apparatus, from one of the PTM_conn mode and the PTP_conn mode to one of the PTM_conn mode, the PTP_conn mode and the PTM_idle mode. Further, the method includes sending, by the host network apparatus, a RRC configuration from the host network to reconfigure the UE to one of the PTM_conn mode, the PTP_conn mode and the PTM_idle mode.

In an embodiment, the method includes receiving, by the host network apparatus, a CSI feedback from the plurality of UEs. Further, the method includes determining, by the host network apparatus, whether the CSI feedback received from each UE of the plurality of UEs meets a weakest UE threshold. Further, the method includes performing, by the host network apparatus, one of: assigning physical resource allocation for multicast per beam or per cell based on the CSI feedback shared by a weakest UE of the plurality of UEs and resource scheduling and assignment for multicast and unicast resources, and triggering beam switch or handover to the UE reported with min CQI, scheduling resource for multicast and unicast resources, and sending a DCI-multicast/unicast resource allocation to inform about the beam switching to the at least one UE of the plurality of UEs.

In an embodiment, the method includes determining, by the host network apparatus, a need to transit the at least one UE to one of an idle mode or an inactive mode based on one of a congestion status, a resource efficiency level, a link condition between the at least one UE and the host network entity, UE's request for preferred RRC state, power saving need of the at least one UE. Further, the method includes signaling, by the host network apparatus, to the at least one UE for a configuration and transition of the at least one UE to one of the idle mode or the inactive mode. Further, the method includes continuing, by the UE, reception of contents from the host network apparatus in one of the idle mode or the inactive mode.

Accordingly, the embodiment herein is to provide a UE for PALS in a communication network. The UE includes a PALS controller communicatively coupled to a memory and a processor. The PALS controller is configured to establish a communication connection with a host network apparatus of the communication network and establish a communication connection with a home network apparatus of the communication network. Further, the PALS controller is configured to select at least one of the home network apparatus or the host network apparatus to access at least one of a multicast service delivery mode, a unicast service delivery mode, or a broadcast service delivery mode based on service prioritization at the UE. Further, the PALS controller is configured to receive content disseminated from at least one of the home network apparatus or the host network apparatus over at least one of the multicast service delivery mode, the unicast service delivery mode, or the broadcast service delivery mode in the communication network using the selected network from the home network apparatus and the host network apparatus.

Accordingly, the embodiment herein is to provide a host network apparatus for PALS in a communication network. The host network apparatus includes a PALS controller communicatively coupled to a memory and a processor. The PALS controller is configured to establish a communication connection with at least one UE from a plurality of UEs in the communication network. Further, the PALS controller is configured to enable for allowing different local service providers and content providers in the communication network to disseminate services and content over one of broadcast, multicast and unicast transport to the at least one UE in the communication network. Further, the PALS controller is configured to disseminate the content to the at least one UE over at least one of a multicast service delivery mode, a unicast service delivery mode, or a broadcast service delivery mode to the at least one UE in the communication network.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The embodiments are illustrated in the accompanying drawings, throughout which like reference letters indicate corresponding parts in the various figures. The embodiments herein will be better understood from the following description with reference to the drawings, in which:

FIG. 1 illustrates an overview of a wireless network for a PALS, according to an embodiment as disclosed herein;

FIG. 2 illustrates various hardware components of a UE, according to an embodiment as disclosed herein;

FIG. 3 illustrates various hardware components of a host network apparatus, according to an embodiment as disclosed herein;

FIG. 4 is a flow chart illustrating a method, implemented by the UE, for the PALS in the communication network, according to the embodiments as disclosed herein;

FIG. 5 is a flow chart illustrating a method, implemented by the host network apparatus, for the PALS in the communication network, according to the embodiments as disclosed herein;

FIG. 6A is an example sequence diagram illustrating a RRC connection established between the UE and the host network apparatus/a home network apparatus, according to the embodiments as disclosed herein;

FIG. 6B is an example sequence diagram illustrating a RRC connection established between the UE and the host network apparatus/home network apparatus in a carrier aggregation mode, according to the embodiments as disclosed herein;

FIG. 6C is an example sequence diagram illustrating a RRC connection release between the UE and the host network apparatus/home network apparatus, according to the embodiments as disclosed herein;

FIG. 7A is an example sequence diagram illustrating a DRX alignment between the UE and the host network apparatus/home network apparatus, according to the embodiments as disclosed herein;

FIG. 7B is an example sequence diagram illustrating service continuity between the UE and the host network apparatus/home network apparatus, according to the embodiments as disclosed herein;

FIG. 8A is an example sequence diagram illustrating the UE handling the content disseminated from the home network apparatus and the host network apparatus over at least one of a multicast service delivery mode, a unicast service delivery mode, or a broadcast service delivery mode, according to the embodiments as disclosed herein;

FIG. 8B is an example sequence diagram illustrating the host network apparatus stitching a home network content with a host network content, according to the embodiments as disclosed herein;

FIG. 9 is an example sequence diagram illustrating the UE sending content received from the host network to other UE over at least one of the multicast service delivery mode, the unicast service delivery mode, or the broadcast service delivery mode using a side link, according to the embodiments as disclosed herein;

FIG. 10A is an example sequence diagram illustrating paging/MBS alignment operations, according to the embodiments as disclosed herein;

FIG. 10B is an example sequence diagram illustrating paging routing operations, according to the embodiments as disclosed herein;

FIG. 11A is an example sequence diagram illustrating a PEI for MBS, according to the embodiments as disclosed herein;

FIG. 11B is an example sequence diagram illustrating a wake up signal (WUS) for the MBS, according to the embodiments as disclosed herein;

FIG. 12 is an example sequence diagram illustrating the UE handling a beam switch or handover with min CQI and scheduling resource for multicast and unicast resources, according to the embodiments as disclosed herein;

FIG. 13A is an example sequence diagram illustrating reconfiguring the UE in one of a PTM_conn mode, a PTP_conn mode and a PTM_idle mode, according to the embodiments as disclosed herein;

FIG. 13B is an example sequence diagram illustrating reconfiguring the UE in one of a PTM_conn mode, a PTP_conn mode and a PTM_idle mode, according to the embodiments as disclosed herein;

FIG. 14 illustrating a scenario of UE operations in a PALS network, according to the embodiments as disclosed herein;

FIG. 15 is an example illustration in which contents are disseminated through plurality of delivery modes including unicast, multicast and broadcast in the PALS network, according to the embodiments as disclosed herein;

FIG. 16 illustrates an inbound and outbound service continuity across the PALS network and a home network, according to the embodiments as disclosed herein;

FIG. 17 illustrates the multiple contents merging in the localized contents, according to the embodiments as disclosed herein;

FIG. 18 illustrates energy efficient delivery mechanism in the PALS network, wherein optimized procedures for paging, mobility, measurements etc. are performed, according to the embodiments as disclosed herein;

FIG. 19 illustrates caching operations at the UE, the PALS network and the home network, according to the embodiments as disclosed herein; and

FIG. 20 illustrates caching operations at the UE, the PALS network and the home network, according to the embodiments as disclosed herein.

### DETAILED DESCRIPTION OF DISCLOSURE

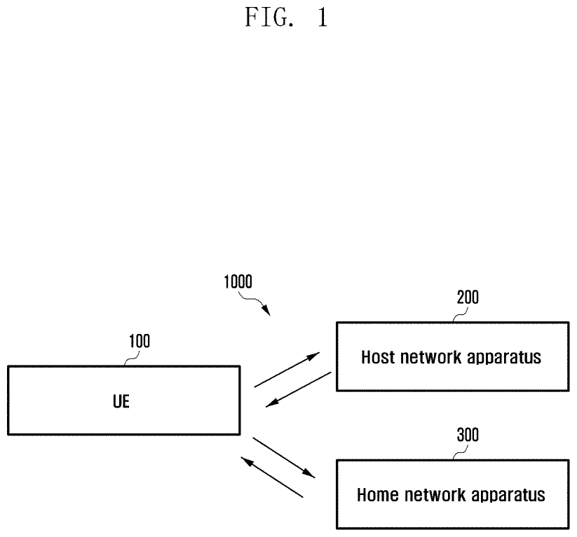

FIGS. 1 through 20, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

In general, a third generation partnership project (3GPP) service architecture group (SA1) is targeting an enhanced communication (5th generation) system support of a hosting a network by providing users/devices access to specific services, offered by a hosting network operator, other mobile operator(s) or 3rd party provider(s). Scenarios for this includes providing access to services through the hosting network could be on demand, temporary and/or cover specific location(s). Further, the operator of the hosting network, or other mobile operator offering services to the users, can be a public land mobile network (PLMN) or non-public network (NPN) operator.

Further, in order to enhance the afore-mentioned communication system framework for the localized services, there is need to support below cases:
1. New use cases supporting diverse localized services;
2. Bringing in more efficient and optimized approaches e.g., with regard to network resources, device/network power consumption;
3. Architectural enhancements for the networks; and/or
4. Enhancements for service delivery mechanism enabling efficient contents dissemination and seamless transitions across different networks or modes of operations.

Thus, it is desired to address the above-mentioned disadvantages or other shortcomings or at least provide a useful alternative.

Accordingly, the embodiment herein is to provide a method for PALS in a communication network. The method includes establishing, by a UE, a communication connection with a host network apparatus of the communication network. Further, the method includes establishing, by the UE, a communication connection with a home network apparatus of the communication network. Further, the method includes selecting, by the UE, at least one of the home network apparatus or the host network apparatus to access at least one of a multicast service delivery mode, a unicast service delivery mode, or a broadcast service delivery mode based on service prioritization at the UE. Further, the method includes receiving, by the UE, content disseminated from at least one of the home network apparatus or the host network apparatus over at least one of the multicast service delivery mode, the unicast service delivery mode, or the broadcast service delivery mode in the communication network using the selected network from the home network apparatus and the host network apparatus.

Referring now to the drawings and more particularly to FIGS. 1 through 20, where similar reference characters denote corresponding features consistently throughout the figures, there are shown preferred embodiments.

FIG. 1 illustrates an overview of a wireless network (1000) for PALS, according to an embodiment as disclosed herein. In an embodiment, the wireless network (1000) includes a UE (100), a host network apparatus (200) and a home network apparatus (300). The wireless network (1000) can be, for example, but not limited to a communication network, a 6G network and an O-RAN network. The UE (100) can be, for example, but not limited to a laptop, a desktop computer, a notebook, a relay device, a Device-to-Device (D2D) device, a vehicle to everything (V2X) device, a smartphone, a tablet, an immersive device, and an internet of things (IoT) device.

The PALS will be offered in the networks where services will benefit from a communication multicast and broadcast services. The network services provided to customers gathered in local spaces such as sports events, concerts or other performing arts will include broadcast and multicast data delivery. Wherever the content is needed simultaneously by a large audience, the resource efficient approach is to make employ multicast and broadcast mechanisms. Here are a number of example scenarios that illustrate the benefits:

TABLE 1

| Host Network/LADN | Services |
|---|---|
| Sports (stadium), Concert Hall | Entertainment, Information, |
| | Advertisements |
| School | Educational services |
| Hospital | Positioning |
| Office/Campus | Authorized Communication services |
| Private industry | Surveillance |
| Mall | Commercial Advertisements |
| Airport/Railway | Infotainment |

The reason that this is an important topic for localized services is that in each of these scenarios, the network and even the venue could be temporary. A sports event or concert may occur where there are no pre-existing facilities or infrastructure. Schools may need to relocate due to a natural disaster or instruction may occur on a ‘field trip.’ Hospitals may need to expand in a crisis situation. Workers may need to use temporary facilities or gather for a conference. Industrial facilities may require network communication only on demand, for example to increase surveillance during construction of a sensitive facility where normal physical access restrictions are not in place. A “Mall” could refer to a periodic trade fair or market. Some transit hubs may require additional network services, e.g., due to extreme weather or other crisis in which many travelers are stranded in the port or station.

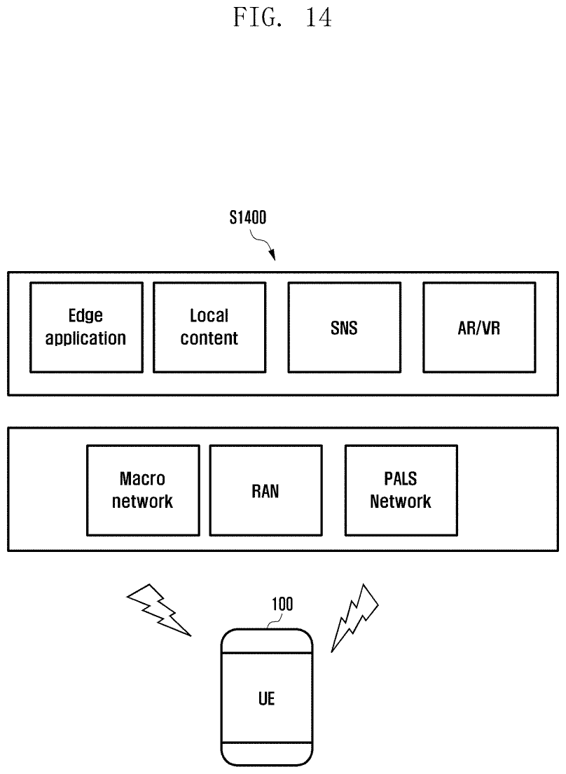

The support for broadcast and multicast in a localized or dense deployment (e.g., a stadium) is elaborated as a scenario and clear example of the value and implications explained in the FIG. 14 to FIG. 20.

In an embodiment, the UE (100) is configured to establish a communication connection with the host network apparatus (200) and establish the communication connection with the home network apparatus (300). Further, the UE (100) is configured to select at least one of the home network apparatus (300) or the host network apparatus (200) to access at least one of a multicast service delivery mode, a unicast service delivery mode, or a broadcast service delivery mode based on service prioritization at the UE (100).

In an embodiment, the UE (100) is configured to determine a plurality of parameters associated with the home network apparatus (300). The plurality of parameters associated with the home network apparatus (300) includes a home network link status, home network measurements, and home network service availability. Further, the UE (100) is configured to determine a plurality of parameters associated with the host network apparatus (200). The plurality of parameters associated with the host network apparatus (200) comprises a host network link status, host network measurements, and host network service availability. Further, the UE (100) is configured to prioritize service from the host network apparatus (200) and the home network apparatus (300) based on the plurality of parameters associated with the home network apparatus (300) and the plurality of parameters associated with the host network apparatus (200). Further, the UE (100) is configured to select one of the home network apparatus (300) and the host network apparatus (200) to access at least one of the multicast service delivery mode, the unicast service delivery mode, or the broadcast service delivery mode based on the service prioritization at the UE (100).

After establishing the communication connection, the host network apparatus (200) is configured to enable for allowing different local service providers and content providers in the communication network (1000) to disseminate services and content over one of broadcast, multicast and unicast transport to the UE (100) in the communication network (1000). Further, the host network apparatus (200) is configured to disseminate the content to the UE (100) over at least one of a multicast service delivery mode, the unicast service delivery mode, or a broadcast service delivery mode to the UE (100) in the communication network (1000).

In an embodiment, the host network apparatus (200) is configured to receive the home network content to be shared to the UE (100) from the home network apparatus (300). Further, the host network apparatus (200) is configured to split the home network content into at least one of the multicast service delivery mode, the unicast service delivery mode, or the broadcast service delivery mode. Further, the host network apparatus (200) is configured to disseminate the home network content over at least one of the multicast service delivery mode, the unicast service delivery mode, or the broadcast service delivery mode to the UE (100).

In an embodiment, the host network apparatus (200) is configured to receive home network content to be shared to the UE (100) from the home network apparatus (300). Further, the host network apparatus (200) is configured to stitch the home network content with host network content and receive the home network content to be routed by the host network apparatus (200). Further, the host network apparatus (200) is configured to disseminate the home network content stitched with the host network content over at least one of the multicast service delivery mode, the unicast service delivery mode, or the broadcast service delivery mode to the UE (100).

Further, the UE (100) is configured to receive content disseminated from at least one of the home network apparatus (300) or the host network apparatus (200) over at least one of the multicast service delivery mode, the unicast service delivery mode, or the broadcast service delivery mode in the communication network (1000) using the selected network from the home network apparatus (300) and the host network apparatus (200). In an embodiment, the UE (100) is configured to receive DRX parameters from one of the home network apparatus (300) and the host network apparatus (200) in order to align a connected mode DRX at the UE (100) to the host network apparatus (200) and a connected mode DRX at the UE (100) to the home network apparatus (300). The DRX parameters can be, for example, but not limited to a DRX cycle length, a DRX ON duration timer, a short DRX cycle, a long DRX cycle, a DRX retransmission timer, DRX RTT timers, and a DRX offset. Further, the UE (100) is configured to receive the content disseminated from the home network apparatus (300) and the host network apparatus (200) over at least one of the multicast service delivery mode, the unicast service delivery mode, or the broadcast service delivery mode based on the alignment of the connected mode DRX at the UE (100) to the host network apparatus (200) and a connected mode DRX at the UE (100) to the home network apparatus (300).

In another embodiment, the UE (100) is configured to receive a caching willingness enquiry message from the host network apparatus (200) and determine whether to receive and cache the content from the host network apparatus (100) based on at least one of a popularity matrix, a battery status of the UE (100), or a storage capacity of the UE (100). The popularity matrix is the measure for popularity of contents which are being cached and it stores the information for the pertinent contents and corresponding number of access requests. The contents can then be treated or discriminated based on their popularities. Further, the UE (100) is configured to send a caching willingness response indicating for caching willingness of the UE (100) to receive and cache the content from the host network apparatus (200) and receive the content from the host network apparatus (200) over at least one of the multicast service delivery mode, the unicast service delivery mode, or the broadcast service delivery mode.

Further, the UE (100) is configured to receive a UE capability request from at least one of the home network apparatus (300) or the host network apparatus (200). Further, the UE (100) is configured to send a UE capability response comprising support for the multiple Tx-Rx to at least one of the host network apparatus (200) or the home network apparatus (300). The UE (100) supports multiple transmission (TX) antennas and multiple reception (RX) antennas and operates in one of carrier aggregation mode with the host network apparatus (200) and the home network apparatus (300) or a dual connectivity mode with the host network apparatus (200) and the home network apparatus (300).

Further, the UE (100) is configured to split the content received from the host network apparatus (200) into at least one of the multicast service delivery mode, the unicast service delivery mode, or the broadcast service delivery mode. Further, the UE (100) is configured to send the content received from the host network apparatus (200) to at least one other UE over at least one of the multicast service delivery mode, the unicast service delivery mode, or the broadcast service delivery mode using a radio link or a side link.

Further, the UE (100) is configured to determine misalignment of the paging occasion and multicast or broadcast service scheduling occasions. Further, the UE (100) is configured to send a GUTI reassignment request to the host network apparatus (200). The GUTI reassignment request is sent to ensure alignment of idle mode DRX cycle of the host network apparatus (200) and the home network apparatus (300). Further, the UE (100) is configured to receive new paging resources information from the host network apparatus (200). The new paging resources information comprises a paging offset and a UE identity.

Further, the UE (100) is configured to receive a paging configuration information including paging sub-group in order to receive a paging for specific multicast or broadcast service delivery modes associated with the sub-group. Further, the UE (100) is configured to receive a paging early indication (PEI) before the paging occasion indicating presence or absence of the sub-group paging for the UE (100) for specific multicast or broadcast service delivery modes associated with the subgroup.

Further, the UE (100) is configured to receive a wakeup signal from one of the home network apparatus (300) and the host network apparatus (200) with an offset before scheduling of traffic from one of the home network apparatus (300) and the host network apparatus (200) to leverage the UE (100) for at least one of multicast service delivery mode allocation, the unicast service delivery mode allocation, or the broadcast service delivery mode allocation. Further, the UE (100) is configured to monitor and receive allocation of at least one of multicast data, unicast data, or broadcast data based on determination of presence of allocation from the wakeup signal. Further, the UE (100) is configured to perform sleep operation based on determination of absence of allocation from the wakeup signal.

Further, the UE (100) is configured to perform a reference signal measurement when the UE (100) is in point to multi-point in idle mode (PTM_Idle) and has subscribed for at least one of the multicast service delivery mode, the unicast service delivery mode, or the broadcast service delivery mode. Further, the UE (100) is configured to determine whether the reference signal measurement meets the reference signal threshold. Further, the UE (100) is configured to send a feedback comprising the reference signal measurements to the host network apparatus (200) in response to determining that the reference signal measurement meets the reference signal threshold, wherein the feedback is sent through one of a RACH message, an idle mode measurement message and a RRC message. The feedback comprising the reference signal measurements is sent to the host network apparatus (200) by utilizing a RACH configuration with RACH resources divided into subgroups, wherein physical resources in each of the subgroup is used to send feedback for a specific multicast and broadcast service delivery modes, and sending the feedback using the RACH message. Further, the UE (100) is configured to receive a RRC configuration from the host network apparatus (200) to configure the UE (100) in one of a Point to multipoint in connected (PTM_conn) mode and a Point to point connected (PTP_conn) mode.

Further, the UE (100) is configured to measure at least one of a beam index (BI), a CQI, a PMI, or a RI when the UE is in one of the PTM_conn mode and the PTP_conn mode. Further, the UE (100) is configured to send a CSI feedback to the host network apparatus (200) and receive a RRC configuration from the host network apparatus (200) to reconfigure the UE (100) to one of the PTM_conn mode, the PTP_conn mode and the PTM_idle mode.

Further, the UE (100) is configured to determine a need to transit to one of an idle mode or an inactive mode based on power saving need of the UE (100), a link condition between the UE (100) and the host network apparatus (200). Further, the UE (100) is configured to signal an indication or a preference to the host network apparatus (200) for the transition to the idle mode or the inactive mode.

Further, the UE (100) is configured to receive signalling from the host network apparatus (200) for the configuration and transition of the UE (100) to one of an idle mode or an inactive mode and transition to one of the idle mode or the inactive mode. Further, the UE (100) is configured to continue for reception of contents from the host network apparatus (200) in one of the idle mode or the inactive mode.

In an embodiment, the host network apparatus (200) is configured to cache the content based on a popularity matrix and send a caching willingness enquiry message to the UE (100). Further, the host network apparatus (200) is configured to receive a caching willingness response indicating willingness of the UE (100) to receive and cache the content from the host network apparatus (200). The host network apparatus (200) split the content into the multicast service delivery mode, the unicast service delivery mode and the broadcast service delivery mode. Further, the host network apparatus (200) is configured to disseminate the home network content over the multicast service delivery mode, the unicast service delivery mode and the broadcast service delivery mode to the UE (100).

Further, the host network apparatus (200) is configured to receive a plurality of requests from the plurality of UEs and determine whether the plurality of requests is greater than, less than or equal to a user request density threshold. In response to determining that the plurality of requests is greater than or equal to the user request density threshold, the host network apparatus (200) is configured to configure one of the multicast service delivery mode and the broadcast service delivery mode to disseminate the content to the UE (100). Alternately, in response to determining that the plurality of requests is less than the user request density threshold, the host network apparatus (200) is configured to configure the unicast service delivery mode to disseminate the content to the UE (100).

Further, the host network apparatus (200) is configured to receive a GUTI reassignment request from the UE (100). The GUTI reassignment request is sent to ensure alignment of idle mode DRX cycle of the host network apparatus (200) and the home network apparatus (300). Further, the host network apparatus (200) is configured to receive a home network paging resources information from the home network apparatus (300). Further, the Host network apparatus (200) is configured to send the home network paging resources information to the UE (100) to receive the content over at least one of the multicast service delivery mode, the unicast service delivery mode, or the broadcast service delivery mode to align the idle mode DRX cycle of the host network apparatus (200) and the home network apparatus (300). The new paging resources information comprises at least one of a paging offset or a UE identity.

Further, the host network apparatus (200) is configured to divide paging resources into subgroups. Further, the host network apparatus (200) is configured to send paging configuration information to the UE (100). The paging configuration information includes the paging sub-group in order to receive a paging for specific multicast or broadcast service delivery modes associated with the sub-group. Further, the host network apparatus (200) is configured to send a paging early indication (PEI) to the UE (100) before the paging occasion indicating presence or absence of the sub-group paging for the UE (100) for specific multicast or broadcast service delivery modes associated with the subgroup.

Further, the host network apparatus (200) is configured to send a wakeup signal to the UE (100) an offset before scheduling of traffic from one of the home network apparatus (300) and the host network apparatus (200) to leverage the UE (100) for at least one of multicast service delivery mode allocation, the unicast service delivery mode allocation, or the broadcast service delivery mode allocation. Further, the host network apparatus (200) is configured to schedule of at least one of multicast data, unicast data, or broadcast data to the UE (100) when presence of allocation is indicated in the wakeup signal to the UE. Further, the host network apparatus (200) is configured to skip scheduling of at least one of multicast data, unicast data, or broadcast data to the UE (100) when absence of allocation is indicated in the wakeup signal to the UE (100).

Further, the host network apparatus (200) is configured to receive a feedback comprising the reference signal measurements from the UE (100), where the feedback is received through one of a RACH message, an idle mode measurement message and a RRC message. Further, the host network apparatus (200) is configured to switch from Point to multipoint idle (PTM_idle) to the one of Point to multipoint connected (PTM_conn) mode and a Point to point connected (PTP_conn) mode. Further, the host network apparatus (200) is configured to send a RRC configuration from the host network apparatus (200) to configure the UE (100) in one of the PTM_conn mode and the PTP_conn mode. Further, the host network apparatus (200) is configured to receive a CSI feedback from the UE (100). Further, the host network apparatus (200) is configured to switch from one of the PTM_conn mode and the PTP_conn mode to one of the PTM_conn mode, the PTP_conn mode and the PTM_idle mode. Further, the host network apparatus (200) is configured to send a RRC configuration from the host network apparatus (200) to reconfigure the UE (100) to one of the PTM_conn mode, the PTP_conn mode and the PTM_idle mode.

Further, the host network apparatus (200) is configured to receive a CSI feedback from the plurality of UEs and determine whether the CSI feedback received from each UE of the plurality of UEs meets a weakest UE threshold. In an embodiment, the host network apparatus (200) is configured to assignee physical resource allocation for multicast per beam or per cell based on the CSI feedback shared by a weakest UE of the plurality of UEs and resource scheduling and assignment for multicast and unicast resources. In another embodiment, the host network apparatus (200) is configured to trigger beam switch or handover to the UE reported with min CQI, scheduling resource for multicast and unicast resources, and sending a DCI-multicast/unicast resource allocation to inform about the beam switching to the at least one UE of the plurality of UEs.

Further, the host network apparatus (200) is configured to determine a need to transit the UE (100) to one of an idle mode or an inactive mode based on one of a congestion status, a resource efficiency level, a link condition between the at least one UE and the host network apparatus (200), UE's request for preferred RRC state, and power saving need of the UE. In an embodiment, the host network apparatus (200) is configured to signal to the UE (100) for a configuration and transition of the UE (100) to one of the idle mode or the inactive mode. Further, the host network apparatus (200) is configured to continue providing contents to the UE (100) in one of the idle mode or the inactive mode.

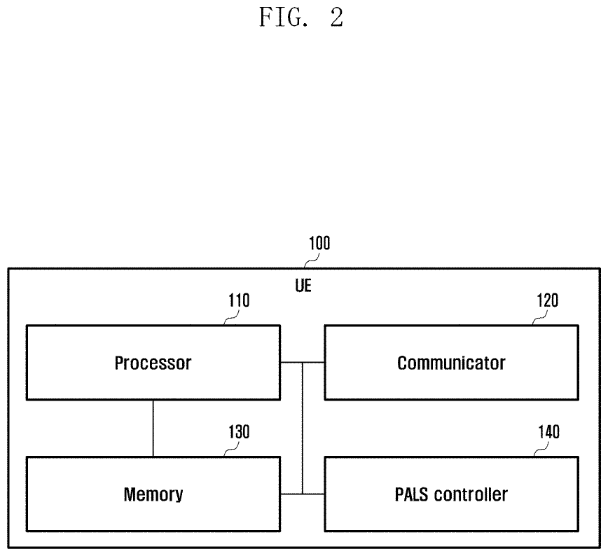

FIG. 2 illustrates various hardware components of the UE (100), according to an embodiment as disclosed herein. In an embodiment, the UE (100) includes a processor (110), a communicator (120), a memory (130) and a PALS controller (140). The processor (110) is communicatively coupled to the communicator (120), the memory (130) and the PALS controller (140).

The PALS controller (140) is configured to establish the communication connection with the host network apparatus (200) and the communication connection with the home network apparatus (300). Further, the PALS controller (140) is configured to select at least one of the home network apparatus (300) or the host network apparatus (200) to access at least one of the multicast service delivery mode, the unicast service delivery mode, or the broadcast service delivery mode based on the service prioritization at the UE (100).

In an embodiment, the PALS controller (140) is configured to determine the plurality of parameters associated with the home network apparatus (300). The plurality of parameters associated with the home network apparatus (300) includes the home network link status, the home network measurements, and the home network service availability. Further, the PALS controller (140) is configured to determine the plurality of parameters associated with the host network apparatus (200). The plurality of parameters associated with the host network apparatus (200) comprises the host network link status, the host network measurements, and the host network service availability. Further, the PALS controller (140) is configured to prioritize service from the host network apparatus (200) and the home network apparatus (300) based on the plurality of parameters associated with the home network apparatus (300) and the plurality of parameters associated with the host network apparatus (200). Further, the PALS controller (140) is configured to select one of the home network apparatus (300) and the host network apparatus (200) to access at least one of the multicast service delivery mode, the unicast service delivery mode, or the broadcast service delivery mode based on the service prioritization at the UE (100).

Further, the PALS controller (140) is configured to receive content disseminated from at least one of the home network apparatus (300) or the host network apparatus (200) over at least one of the multicast service delivery mode, the unicast service delivery mode, or the broadcast service delivery mode in the communication network (1000) using the selected network from the home network apparatus (300) and the host network apparatus (200).

In an embodiment, the PALS controller (140) is configured to receive DRX parameters from one of the home network apparatus (300) and the host network apparatus (200) in order to align the connected mode DRX at the UE (100) to the host network apparatus (200) and a connected mode DRX at the UE (100) to the home network apparatus (300). Further, the PALS controller (140) is configured to receive the content disseminated from the home network apparatus (300) and the host network apparatus (200) over at least one of the multicast service delivery mode, the unicast service delivery mode, or the broadcast service delivery mode based on the alignment of the connected mode DRX at the UE (100) to the host network apparatus (200) and a connected mode DRX at the UE (100) to the home network apparatus (300).

In another embodiment, the PALS controller (140) is configured to receive a caching willingness enquiry message from the host network apparatus (200) and determine whether to receive and cache content received from the host network apparatus (200) based on at least one of a popularity matrix, a battery status of the UE (100), or a storage capacity of the UE (100). Further, the PALS controller (140) is configured to send a caching willingness response indicating for caching willingness of the UE (100) to receive and cache the content from the host network apparatus (200) and receive and cache the content from the home network apparatus (200) over at least one of the multicast service delivery mode, the unicast service delivery mode, or the broadcast service delivery mode.

Further, the PALS controller (140) is configured to receive the UE capability request from at least one of the home network apparatus (300) or the host network apparatus (200). Further, the PALS controller (140) is configured to send the UE capability response comprising support for the multiple Tx-Rx to at least one of the host network apparatus (200) or the home network apparatus (300). The UE (100) supports multiple transmission (TX) antennas and multiple reception (RX) antennas and operates in one of carrier aggregation mode with the host network apparatus (200) and the home network apparatus (300) or the dual connectivity mode with the host network apparatus (200) and the home network apparatus (300).

Further, the PALS controller (140) is configured to split the content received from the host network apparatus (200) into at least one of the multicast service delivery mode, the unicast service delivery mode, or the broadcast service delivery mode. Further, the PALS controller (140) is configured to send the content received from the host network apparatus (200) to at least one other UE over at least one of the multicast service delivery mode, the unicast service delivery mode, or the broadcast service delivery mode using a radio link or a side link.

Further, the PALS controller (140) is configured to determine misalignment of the paging occasion and multicast or broadcast service scheduling occasions. Further, the PALS controller (140) is configured to send a GUTI reassignment request to the host network apparatus (200). Further, the PALS controller (140) is configured to receive new paging resources information from the host network apparatus (200). The new paging resources information comprises a paging offset and a UE identity.

Further, the PALS controller (140) is configured to receive a paging configuration information including paging sub-group in order to receive a paging for specific multicast or broadcast service delivery modes associated with the sub-group. Further, the PALS controller (140) is configured to receive a paging early indication (PEI) before the paging occasion indicating presence or absence of the sub-group paging for the UE (100) for specific multicast or broadcast service delivery modes associated with the subgroup.

Further, the PALS controller (140) is configured to receive the wakeup signal from one of the home network apparatus (300) and the host network apparatus (200) with the offset before scheduling of traffic from one of the home network apparatus (300) and the host network apparatus (200) to leverage the UE (100) for at least one of multicast service delivery mode allocation, the unicast service delivery mode allocation, or the broadcast service delivery mode allocation. Further, the PALS controller (140) is configured to monitor and receive allocation of at least one of multicast data, unicast data, or broadcast data based on determination of presence of allocation from the wakeup signal. Further, the PALS controller (140) is configured to perform sleep operation based on determination of absence of allocation from the wakeup signal.

Further, the PALS controller (140) is configured to perform a reference signal measurement when the UE (100) is in point to multi-point in idle mode (PTM_Idle) and has subscribed for at least one of the multicast service delivery mode, the unicast service delivery mode, or the broadcast service delivery mode. Further, the PALS controller (140) is configured to determine whether the reference signal measurement meets the reference signal threshold. Further, the PALS controller (140) is configured to send a feedback comprising the reference signal measurements to the host network apparatus (200) in response to determining that the reference signal measurement meets the reference signal threshold, wherein the feedback is sent through one of a RACH message, an idle mode measurement message and a RRC message. The feedback comprising the reference signal measurements is sent to the host network apparatus (200) by utilizing a RACH configuration with RACH resources divided into subgroups, wherein physical resources in each of the subgroup is used to send feedback for a specific multicast and broadcast service delivery modes, and send the feedback using the RACH message. Further, the PALS controller (140) is configured to receive a RRC configuration from the host network apparatus (200) to configure the UE (100) in one of a Point to multipoint in connected (PTM_conn) mode and a Point to point connected (PTP_conn) mode.

Further, the PALS controller (140) is configured to measure at least one of the BI, the CQI, the PMI, or the RI when the UE (100) is in one of the PTM_conn mode and the PTP_conn mode. Further, the PALS controller (140) is configured to send a CSI feedback to the host network apparatus (200) and receive a RRC configuration from the host network apparatus (200) to reconfigure the UE (100) to one of the PTM_conn mode, the PTP_conn mode and the PTM_idle mode.

Further, the PALS controller (140) is configured to determine a need to transit to one of an idle mode or an inactive mode based on power saving need of the UE (100), a link condition between the UE (100) and the host network apparatus (200). Further, the PALS controller (140) is configured to signal an indication or a preference to the host network apparatus (200) for the transition to the idle mode or the inactive mode.

Further, the PALS controller (140) is configured to receive signalling from the host network apparatus (200) for the configuration and transition of the UE (100) to one of an idle mode or an inactive mode and transition to one of the idle mode or the inactive mode. Further, the PALS controller (140) is configured to continue for reception of contents from the host network apparatus (200) in one of the idle mode or the inactive mode.

The PALS controller (140) is physically implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in random access memory (RAM) or cache).

Although the FIG. 2 shows various hardware components of the UE (100) but it is to be understood that other embodiments are not limited thereon. In other embodiments, the UE (100) may include less or more number of components. Further, the labels or names of the components are used only for illustrative purpose and does not limit the scope of the present disclosure. One or more components can be combined together to perform same or substantially similar function in the UE (100).

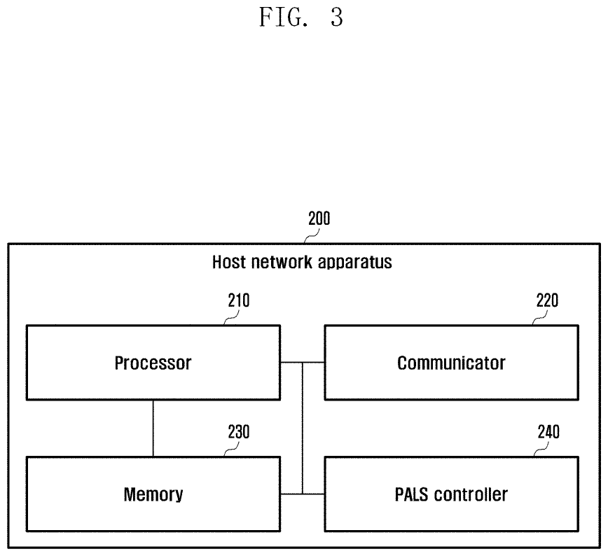

FIG. 3 shows various hardware components of the host network apparatus (200), according to an embodiment as disclosed herein. In an embodiment, the host network apparatus (200) includes a processor (210), a communicator (220), a memory (230) and a PALS controller (240). The processor (210) is communicatively coupled to the communicator (220), the memory (230) and the PALS controller (240).

The PALS controller (240) is configured to establish the communication connection with at least one UE from the plurality of UEs in the communication network (1000). After establishing the communication connection, the PALS controller (240) is configured to enable for allowing different local service providers and content providers in the communication network (1000) to disseminate services and content over one of broadcast, multicast and unicast transport to the UE (100) in the communication network (1000). Further, the PALS controller (240) is configured to disseminate the content to the UE (100) over at least one of the multicast service delivery mode, the unicast service delivery mode, or a broadcast service delivery mode to the UE (100) in the communication network (1000).

In an embodiment, the PALS controller (240) is configured to receive the home network content to be shared to the UE (100) from the home network apparatus (300). Further, the PALS controller (240) is configured to split the home network content into at least one of the multicast service delivery mode, the unicast service delivery mode, or the broadcast service delivery mode. Further, the PALS controller (240) is configured to disseminate the home network content over at least one of the multicast service delivery mode, the unicast service delivery mode, or the broadcast service delivery mode to the UE (100).

In an embodiment, the PALS controller (240) is configured to receive home network content to be shared to the UE (100) from the home network apparatus (300). Further, the PALS controller (240) is configured to stitch the home network content with the host network content and receive the home network content to be routed by the host network apparatus (200). Further, the PALS controller (240) is configured to disseminate the home network content stitched with the host network content over at least one of the multicast service delivery mode, the unicast service delivery mode, or the broadcast service delivery mode to the UE (100).

In an embodiment, the PALS controller (240) is configured to cache the content based on the popularity matrix and send the caching willingness enquiry message to the UE (100). Further, the PALS controller (240) is configured to receive the caching willingness response indicating caching willingness of the UE (100) to receive and cache the content from the host network apparatus (200) and split the content into the multicast service delivery mode, the unicast service delivery mode and the broadcast service delivery mode. Further, the PALS controller (240) is configured to disseminate the home network content over the multicast service delivery mode, the unicast service delivery mode and the broadcast service delivery mode to the UE (100).

Further, the PALS controller (240) is configured to receive a plurality of requests from the plurality of UEs and determine whether the plurality of requests is greater than, less than or equal to a user request density threshold. In response to determining that the plurality of requests is greater than or equal to the user request density threshold, the PALS controller (240) is configured to configure one of the multicast service delivery mode and the broadcast service delivery mode to disseminate the content to the UE (100). Alternately, in response to determining that the plurality of requests is less than the user request density threshold, the PALS controller (240) is configured to configure the unicast service delivery mode to disseminate the content to the UE (100).

Further, the PALS controller (240) is configured to receive the GUTI reassignment request from the UE (100). The GUTI reassignment request is sent to ensure alignment of idle mode DRX cycle of the host network apparatus (200) and the home network apparatus (300). Further, the PALS controller (240) is configured to receive the home network paging resources information from the home network apparatus (300). Further, the PALS controller (240) is configured to send the home network paging resources information to the UE (100) to receive the content over at least one of the multicast service delivery mode, the unicast service delivery mode, or the broadcast service delivery mode to align the idle mode DRX cycle of the host network apparatus (200) and the home network apparatus (300). The new paging resources information comprises at least one of a paging offset or a UE identity.

Further, the PALS controller (240) is configured to divide paging resources into subgroups. Further, the PALS controller (240) is configured to send the paging configuration information to the UE (100). The paging configuration information includes the paging sub-group in order to receive a paging for specific multicast or broadcast service delivery modes associated with the sub-group. Further, the PALS controller (240) is configured to send a paging early indication (PEI) to the UE (100) before the paging occasion indicating presence or absence of the sub-group paging for the UE (100) for specific multicast or broadcast service delivery modes associated with the subgroup.

Further, the PALS controller (240) is configured to send a wakeup signal to the UE (100) an offset before scheduling of traffic from one of the home network apparatus (300) and the host network apparatus (200) to leverage the UE (100) for at least one of multicast service delivery mode allocation, the unicast service delivery mode allocation, or the broadcast service delivery mode allocation. Further, the PALS controller (240) is configured to schedule of at least one of multicast data, unicast data, or broadcast data to the UE (100) when presence of allocation is indicated in the wakeup signal to the UE. Further, the PALS controller (240) is configured to skip scheduling of at least one of multicast data, unicast data, or broadcast data to the UE (100) when absence of allocation is indicated in the wakeup signal to the UE (100).

Further, the PALS controller (240) is configured to receive a feedback comprising the reference signal measurements from the UE (100), where the feedback is received through one of a RACH message, an idle mode measurement message and a RRC message. Further, the PALS controller (240) is configured to switch from Point to multipoint idle (PTM_idle) to the one of Point to multipoint connected (PTM_conn) mode and a Point to point connected (PTP_conn) mode. Further, the PALS controller (240) is configured to send a RRC configuration from the host network apparatus (200) to configure the UE (100) in one of the PTM_conn mode and the PTP_conn mode. Further, the PALS controller (240) is configured to receive a CSI feedback from the UE (100). Further, the PALS controller (240) is configured to switch from one of the PTM_conn mode and the PTP_conn mode to one of the PTM_conn mode, the PTP_conn mode and the PTM_idle mode. Further, the PALS controller (240) is configured to send a RRC configuration from the host network apparatus (200) to reconfigure the UE (100) to one of the PTM_conn mode, the PTP_conn mode and the PTM_idle mode.

Further, the PALS controller (240) is configured to receive a CSI feedback from the plurality of UEs and determine whether the CSI feedback received from each UE of the plurality of UEs meets a weakest UE threshold. In an embodiment, the PALS controller (240) is configured to assignee physical resource allocation for multicast per beam or per cell based on the CSI feedback shared by a weakest UE of the plurality of UEs and resource scheduling and assignment for multicast and unicast resources. In another embodiment, the PALS controller (240) is configured to trigger beam switch or handover to the UE reported with min CQI, scheduling resource for multicast and unicast resources, and sending a DCI-multicast/unicast resource allocation to inform about the beam switching to the at least one UE of the plurality of UEs.

Further, the PALS controller (240) is configured to determine a need to transit the UE (100) to one of an idle mode or an inactive mode based on one of a congestion status, a resource efficiency level, a link condition between the at least one UE and the host network apparatus (200), UE's request for preferred RRC state, and power saving need of the UE. In an embodiment, the PALS controller (240) is configured to signal to the UE (100) for a configuration and transition of the UE (100) to one of the idle mode or the inactive mode. Further, the PALS controller (240) is configured to continue providing contents to the UE (100) in one of the idle mode or the inactive mode.

The PALS controller (240) is physically implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (210) is configured to execute instructions stored in the memory (230) and to perform various processes. The communicator (220) is configured for communicating internally between internal hardware components and with external devices via one or more networks. The memory (230) also stores instructions to be executed by the processor (210). The memory (230) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. However, the term “non-transitory” should not be interpreted that the memory (230) is non-movable. In certain examples, a non-transitory storage medium may store data that can, over time, change (e.g., in Random Access Memory (RAM) or cache).

Although the FIG. 3 shows various hardware components of the host network apparatus (200) but it is to be understood that other embodiments are not limited thereon. In other embodiments, the host network apparatus (200) may include less or more number of components. Further, the labels or names of the components are used only for illustrative purpose and does not limit the scope of the present disclosure. One or more components can be combined together to perform same or substantially similar function in the host network apparatus (200).

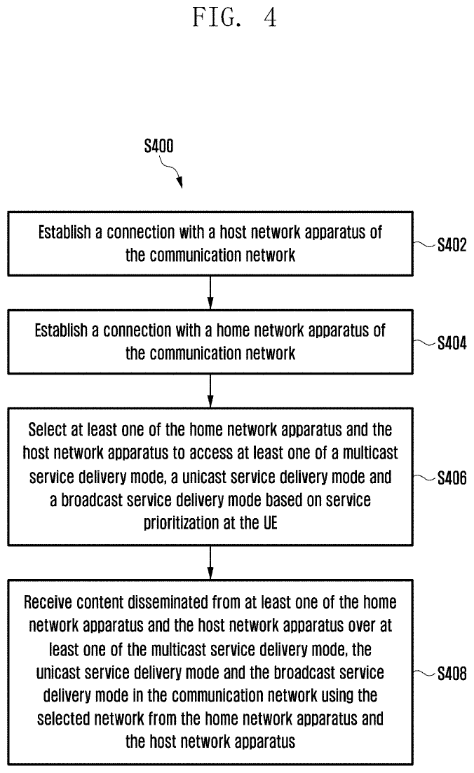

FIG. 4 is a flow chart (S400) illustrating a method, implemented by the UE (100), for PALS in the communication network (1000), according to the embodiments as disclosed herein. The operations (S402-S408) are performed by the PALS controller (140).

At S402, the method includes establishing the communication connection with the host network apparatus (200) of the communication network (1000). At S404, the method includes establishing the communication connection with the home network apparatus (300) of the communication network (1000). At S406, the method includes selecting at least one of the home network apparatus (300) or the host network apparatus (200) to access at least one of the multicast service delivery mode, the unicast service delivery mode, or the broadcast service delivery mode based on service prioritization at the UE (100).

At S408, the method includes receiving content disseminated from at least one of the home network apparatus (300) or the host network apparatus (200) over at least one of the multicast service delivery mode, the unicast service delivery mode, or the broadcast service delivery mode in the communication network (1000) using the selected network from the home network apparatus (300) and the host network apparatus (200).

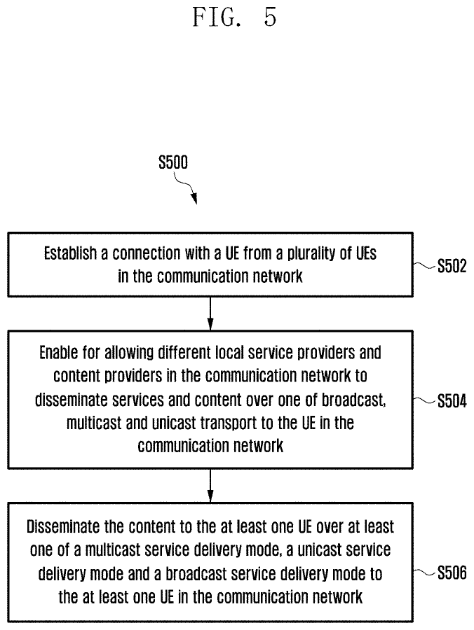

FIG. 5 is a flow chart (S500) illustrating a method, implemented by the host network apparatus (200), for PALS in the communication network (1000), according to the embodiments as disclosed herein. The operations (S502-S506) are performed by the PALS controller (240).

At S502, the method includes establishing the communication connection with at least one UE (100) from the plurality of UEs in the communication network (1000). At S504, the method includes enabling for allowing different local service providers and content providers in the communication network (1000) to disseminate services and content over one of broadcast, multicast and unicast transport to the at least one UE (100) in the communication network (1000). At S506, the method includes disseminating the content to the at least one UE over at least one of a multicast service delivery mode, a unicast service delivery mode, or a broadcast service delivery mode to the at least one UE (100) in the communication network (1000).

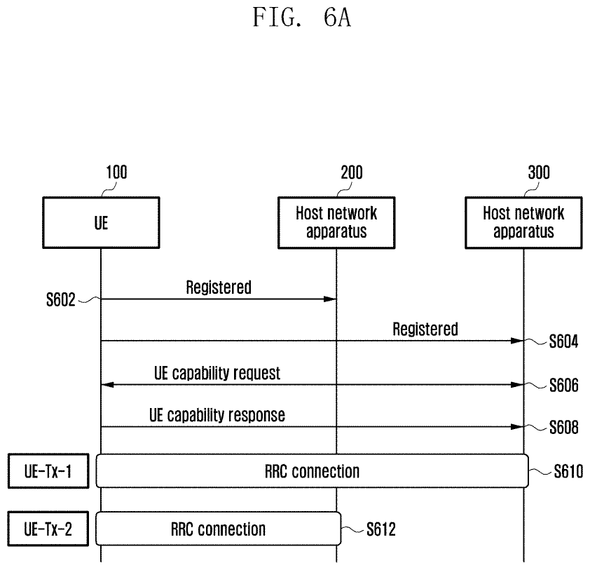

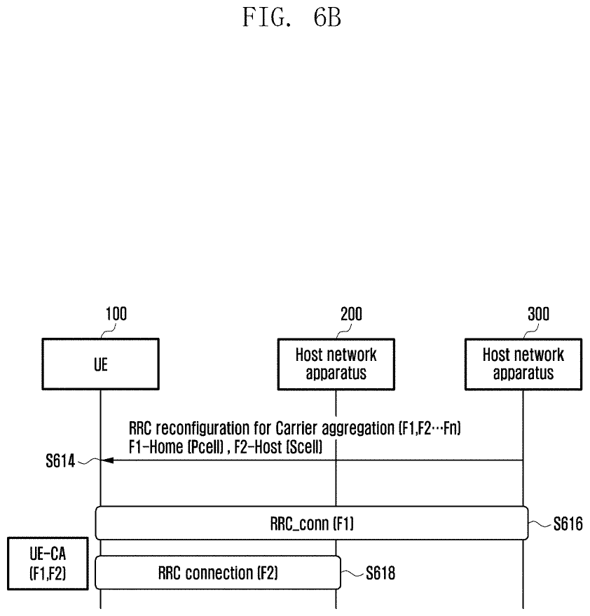

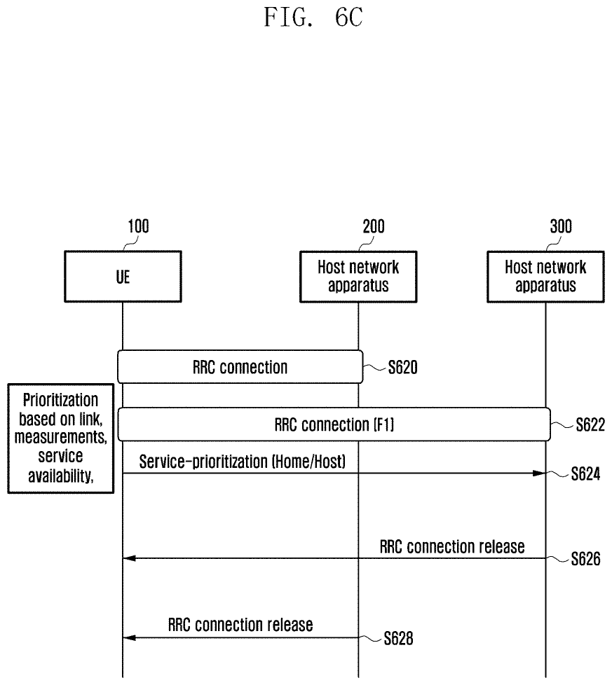

FIG. 6A is an example sequence diagram illustrating the RRC connection established between the UE (100) and the host network apparatus (200)/home network apparatus (300), according to the embodiments as disclosed herein.

At S602, the UE (100) is registered with the host network apparatus (200). At 604, the UE (100) is registered with the home network apparatus (300). At S606, the home network apparatus (300) sends the UE capability request to the UE (100). At S608, the UE (100) sends the UE capability response to the home network apparatus (300) based on the UE capability request. At S610, a RRC connection is established between the UE (100) and the home network apparatus (300) using a UE-Tx-1. At S612, a RRC connection is established between the UE (100) and the host network apparatus (200) using a UE-Tx-2.

FIG. 6B is an example sequence diagram illustrating the RRC connection established between the UE (100) and the host network apparatus (200)/home network apparatus (300) in the carrier aggregation mode, according to the embodiments as disclosed herein.

At S614, the home network apparatus (300) sends the RRC reconfiguration for the carrier aggregation (F1, F2 . . . Fn) to the UE (100). At S616, a RRC connection is established between the UE (100) and the home network apparatus (300) using a Pcell. At S618, a RRC connection is established between the UE (100) and the host network apparatus (200) using a Scell.

FIG. 6C is an example sequence diagram illustrating the RRC connection release between the UE (100) and the host network apparatus (200)/home network apparatus (300), according to the embodiments as disclosed herein.

At S620, the RRC connection is established between the UE (100) and the host network apparatus (200). At S622, the RRC connection is established between the UE (100) and the home network apparatus (300) using the Pcell. At S624, the UE (100) prioritizes the service from the host network apparatus (200) and the home network apparatus (300) based on the plurality of parameters associated with the home network apparatus and the plurality of parameters associated with the host network apparatus. At S626, the home network apparatus (300) sends a RRC connection release to the UE (100). At S628, the host network apparatus (200) sends the RRC connection release to the UE (100).

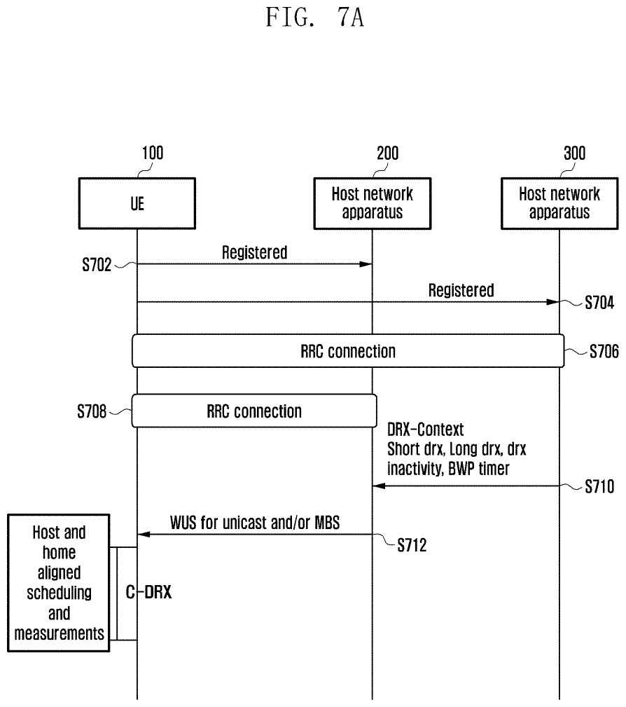

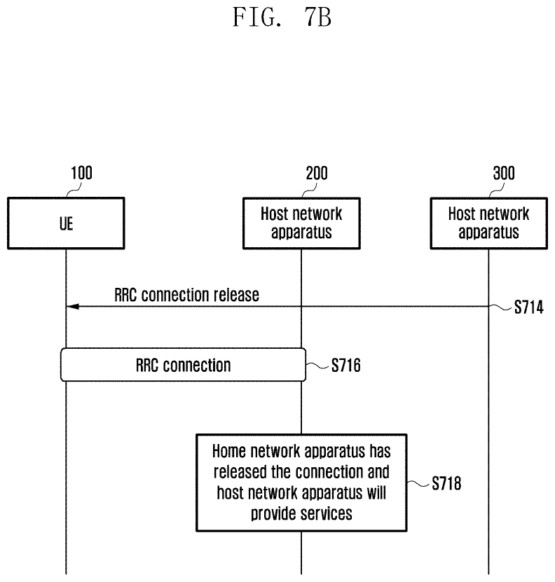

FIG. 7A is an example sequence diagram illustrating the DRX alignment between the UE (100) and the host network apparatus (200)/home network apparatus (300), according to the embodiments as disclosed herein

At S702, the UE (100) is registered with the host network apparatus (200). At 704, the UE (100) is registered with the home network apparatus (300). At S706, the RRC connection is established between the UE (100) and the home network apparatus (300). At S708, the RRC connection is established between the UE (100) and the host network apparatus (200). At S710 and 5712, the UE (100) receives the DRX parameters from one of the home network apparatus (300) and the host network apparatus (200) in order to align the connected mode DRX at the UE (100) to the host network apparatus (200) and a connected mode DRX at the UE (100) to the home network apparatus (300).

FIG. 7B is an example sequence diagram illustrating a service continuity between the UE (100) and the host network apparatus (200)/home network apparatus (300), according to the embodiments as disclosed herein

At S714, the home network apparatus (300) sends the RRC connection release message to the UE (100). At S716, the RRC connection is established between the UE (100) and the host network apparatus (200). At S718, the home network apparatus (300) has released the connection and the host network apparatus (200) will provide services to the UE (100).

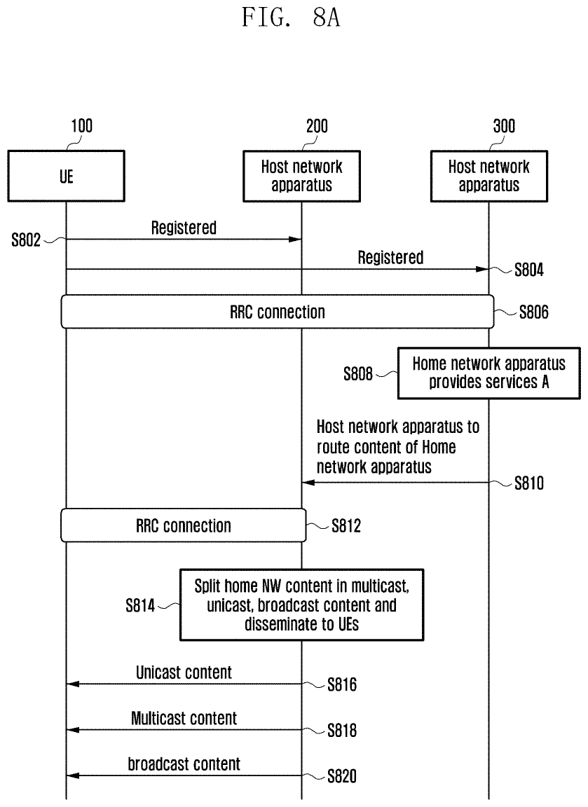

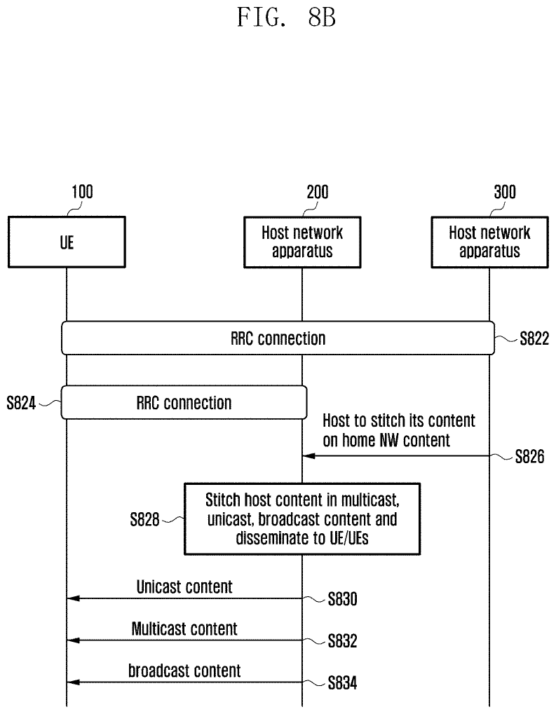

FIG. 8A is an example sequence diagram illustrating the UE (100) handling the content disseminated from the home network apparatus (300) and the host network apparatus (200) over at least one of the multicast service delivery mode, the unicast service delivery mode, or the broadcast service delivery mode, according to the embodiments as disclosed herein.

At S802, the UE (100) is registered with the host network apparatus (200). At 804, the UE (100) is registered with the home network apparatus (300). At S806, the RRC connection is established between the UE (100) and the home network apparatus (300). At S808, the home network apparatus (300) provides the services. At S810, the host network apparatus (200) routes content of home network apparatus (300). At S812, the RRC connection is established between the UE (100) and the host network apparatus (200). At 814, the host network apparatus (200) splits the home network content into multicast content, unicast content, and broadcast content and disseminate to UEs. At S816, the host network apparatus (200) sends the unicast content to the UE (100). At S818, the host network apparatus (200) sends the multicast content to the UE (100). At S820, the host network apparatus (200) sends the broadcast content to the UE (100).

FIG. 8B is an example sequence diagram illustrating the host network apparatus (200) stitching the home network content with host network content, according to the embodiments as disclosed herein.

At S822, the RRC connection is established between the UE (100) and the home network apparatus (300). At S824, the RRC connection is established between the UE (100) and the host network apparatus (200). At S826, the host network apparatus (200) stitches its content on the home network content. At S828, the host network apparatus (200) stitches the host content in the multicast content, the unicast content, and the broadcast content and disseminate to UE/UEs. At S830, the host network apparatus (200) sends the unicast content to the UE (100). At S832, the host network apparatus (200) sends the multicast content to the UE (100). At S834, the host network apparatus (200) sends the broadcast content to the UE (100).

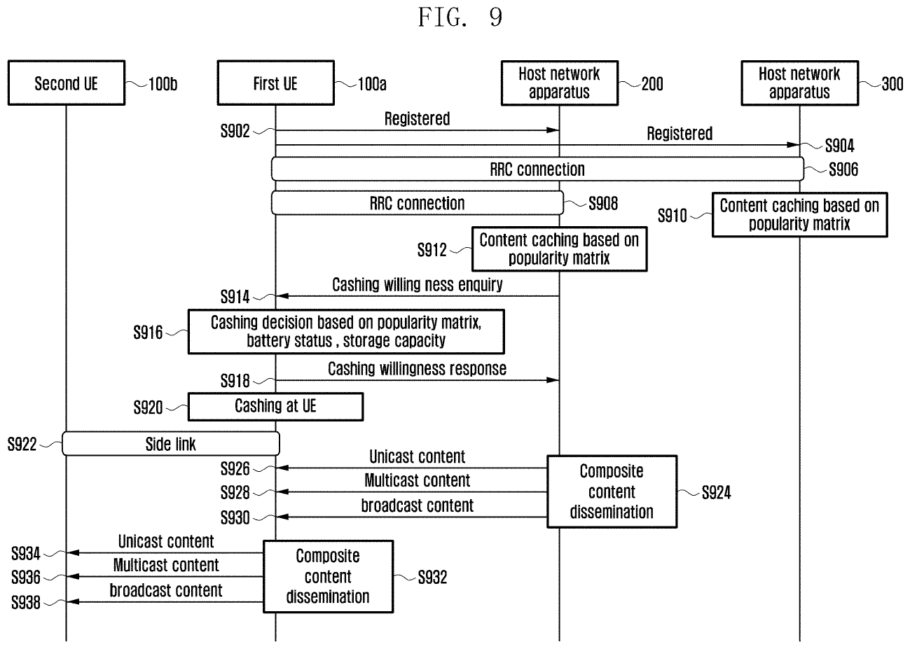

FIG. 9 is an example sequence diagram illustrating the UE sends the content received from the host network apparatus (200) to other UE over at least one of the multicast service delivery mode, the unicast service delivery mode, or the broadcast service delivery mode using a side link, according to the embodiments as disclosed herein.

At S902, the UE (100) is registered with the host network apparatus (200). At 904, the UE (100) is registered with the home network apparatus (300). At S906, the RRC connection is established between the UE (100) and the home network apparatus (300). At S908, a RRC connection is established between the UE (100) and the host network apparatus (200). At SA910, the home network apparatus (300) performs the content caching based on the popularity matrix. At S912, the host network apparatus (200) performs the content caching based on the popularity matrix. At S914, the host network apparatus (200) sends the caching willingness enquiry to the UE (100a). At S916, the UE (100) performs a caching decision based on the popularity matrix, the battery status, and the storage capacity.

At S918, the UE (100a) sends the caching willingness response to the host network apparatus (200). At S920, the UE (100a) performs the caching. At S922, the side link is established between the UE (100a) and another UE (100b). At S924, the host network apparatus (200) performs the composite content dissemination to the UE (100a). At S926, the host network apparatus (200) sends the unicast content to the UE (100). At S928, the host network apparatus (200) sends the multicast content to the UE (100). At S930, the host network apparatus (200) sends the broadcast content to the UE (100). At S932, the UE (100) performs the composite content dissemination to another UE (100b). At S934, the UE (100a) sends the unicast content to another UE (100b). At S936, the UE (100a) sends the multicast content to another UE (100b). At S938, the UE (100a) sends the broadcast content to another UE (100b).

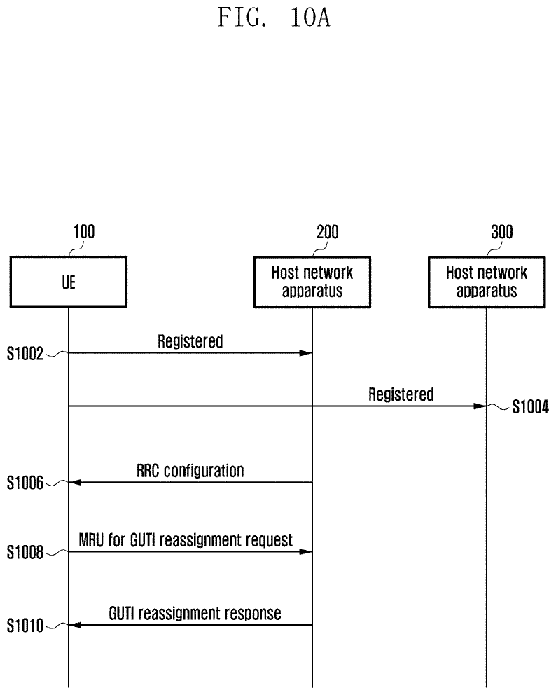

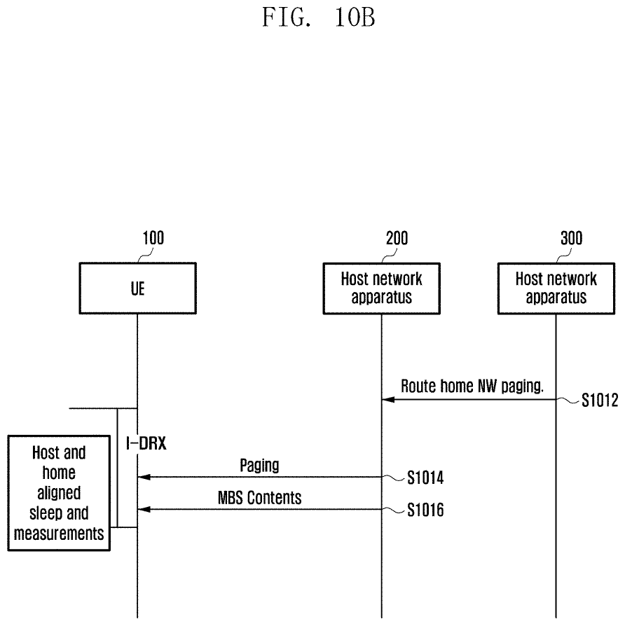

FIG. 10A is an example sequence diagram illustrating paging/MBS alignment operations, according to the embodiments as disclosed herein

At S1002, the UE (100) is registered with the host network apparatus (200). At S1004, the UE (100) is registered with the home network apparatus (300). At 51006, the host network apparatus (200) sends a RRC connection request to the UE (100). At S1008, the UE (100) sends a mobility registration update (MRU) for a GUTI reassignment request to the host network apparatus (200). The GUTI reassignment request is sent to ensure alignment of idle mode DRX cycle of the host network apparatus (200) and the home network apparatus (300). At 51010, the host network apparatus (200) sends a GUTI reassignment response to the UE (100).

FIG. 10B is an example sequence diagram illustrating paging routing operations, according to the embodiments as disclosed herein. At S1012, the home network apparatus (300) routes the home NW paging to the host network apparatus (200). At 51014, the host network apparatus (200) sends the paging to the UE (100). The UE (100) aligns the DRX cycle of the home network apparatus (300) and the host network apparatus (200). At 51016, the host network apparatus (200) sends the MBS contents to the UE (100).

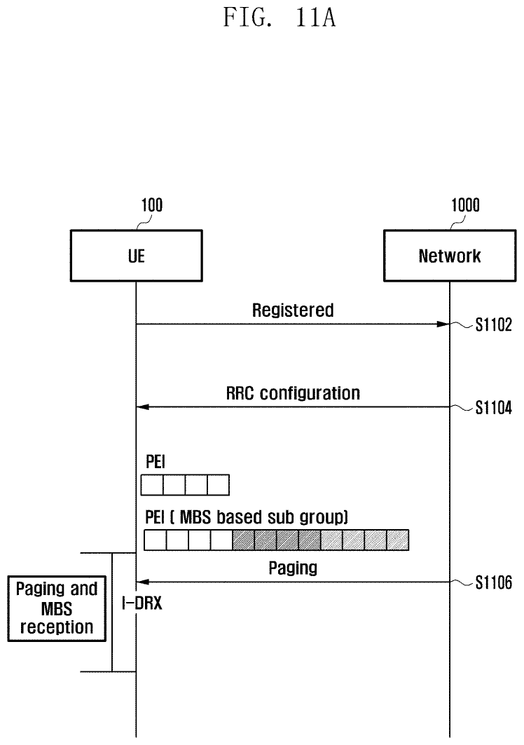

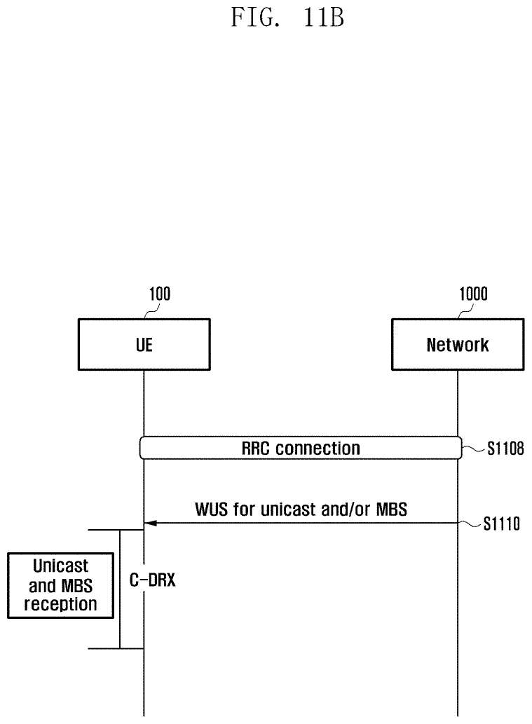

FIG. 11A is an example sequence diagram illustrating a PEI for MBS, according to the embodiments as disclosed herein. At S1102, the UE (100) is registered with the network (1000). At 51104, the network (1000) sends a RRC configuration to the UE (100). At S1106, the network (1000) sends the PEI before the paging occasion indicating presence or absence of the sub-group paging for the UE (100) for specific multicast or broadcast service delivery modes associated with the subgroup. One or more paging sub-groups in the PEI can therefore be associated with group paging or group notification for the multicast service (e.g., indicating an activation notification).

FIG. 11B is an example sequence diagram illustrating a wake-up signal (WUS) for MBS, according to the embodiments as disclosed herein. At 51108, the network (1000) sends the RRC configuration to the UE (100). At 51110, the network (1000) sends a WUS for unicast and/or MBS to the UE (100). WUS indicates the presence or absence of allocation of the unicast and/or MBS reception. The UE receives a wakeup signal from one of the home network apparatus and the host network apparatus with an offset before scheduling of traffic from one of the home network apparatus and the host network apparatus to leverage the UE for at least one of multicast service delivery mode allocation, the unicast service delivery mode allocation, or the broadcast service delivery mode allocation. Further, the UE monitors and receives allocation of at least one of multicast data, unicast data, or broadcast data based on determination of presence of allocation from the wakeup signal. Further, the UE performs sleep operation based on determination of absence of allocation from the wakeup signal. A separate wakeup signal can be associated with each PTM MBS services configured with different DRX configurations.

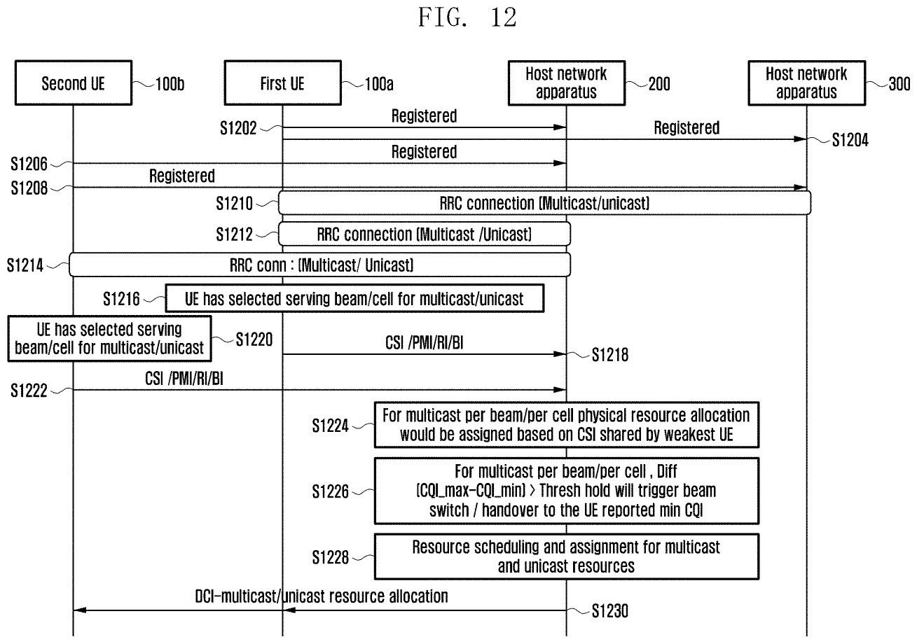

FIG. 12 is an example sequence diagram illustrating the UE (100a and 100b) handling the beam switch or handover with min CQI and scheduling resource for multicast and unicast resources, according to the embodiments as disclosed herein. At 51202, the UE (100a) is registered with the host network apparatus (200). At 51204, the UE (100a) is registered with the home network apparatus (300). At 51206, the UE (100b) is registered with the host network apparatus (200). At S1208, the UE (100b) is registered with the home network apparatus (300).

At 51210, the RRC connection for the multicast/unicast is established between the UE (100a) and the home network apparatus (300). At 51212, the RRC connection for the multicast/unicast is established between the UE (100a) and the host network apparatus (200). At S1214, the RRC connection for the multicast/unicast is established between the UE (100b) and the host network apparatus (200).

At 51216, the UE (100a) has selected serving beam/cell for the multicast/unicast. At S1218, the UE (100a) sends the CSI/PMI/RI/BI to the host network apparatus (200). At 51220, the UE (100b) has selected serving beam/cell for multicast/unicast. At 51222, the UE (100a) sends the CSI/PMI/RI/BI to the host network apparatus (200).

At S1224, for multicast per beam/per cell physical resource allocation would be assigned based on the CSI shared by weakest UE. At 51226, for multicast per beam/per cell, difference (CQI_max−CQI_min)>Thresh hold will trigger beam switch/handover to the UE reported min CQI. At 51228, the host network apparatus (200) performs the resource scheduling and assignment for multicast and unicast resources. At 51230, the host network apparatus (200) sends the DCI-multicast/unicast resource allocation to the UE (100a and 100b).

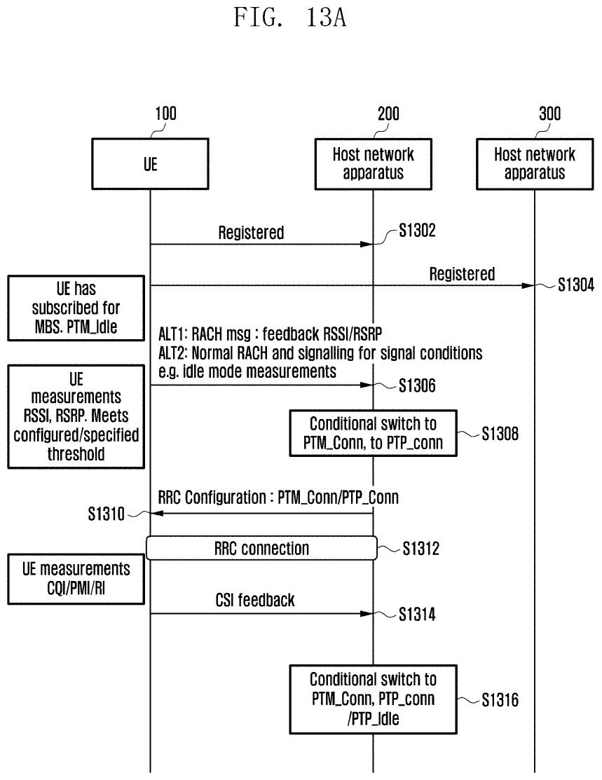

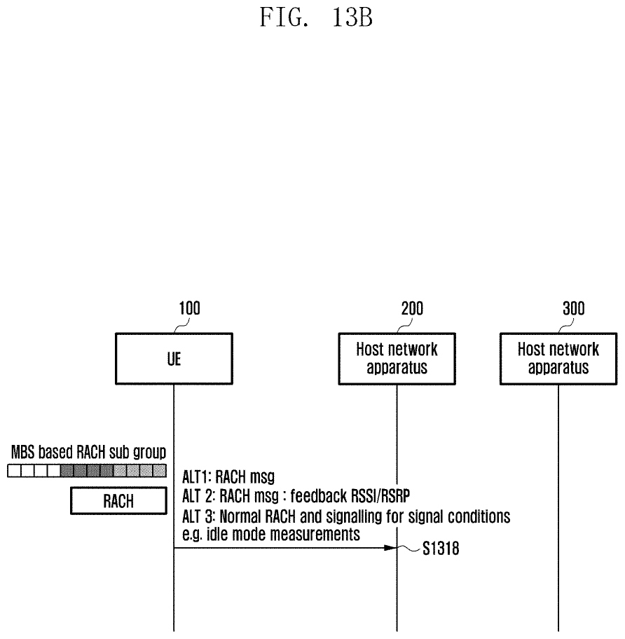

FIG. 13A and FIG. 13B are example sequence diagrams illustrating reconfiguring the UE to one of the PTM_conn mode, the PTP_conn mode and the PTM_idle mode, according to the embodiments as disclosed herein.

At S1302, the UE (100) is registered with the host network apparatus (200). At S1304, the UE (100) is registered with the home network apparatus (300). The UE (100) has subscribed for the MBS and the UE (100) is in the PTM_idle mode.

At 51306, the UE (100) sends the RACH message indicating a feedback of RSSI/RSRP to the host network apparatus (200) or the UE (100) sends the normal RACH and signalling for signal conditions (e.g., idle mode measurements) to the host network apparatus (200).

At 51308, the host network apparatus (200) performs the conditional switch to the PTM_connection to PTP_connection. At S1310, the host network apparatus (200) sends the RRC configuration for PTM_connection/PTP_connection to the UE (100). At 51312, the RRC connection is established between the UE (100) and the host network apparatus (200). The UE (100) performs the measurements for CQI/PMI/RI. At S1314, the UE (100) sends the CSI feedback to the host network apparatus (200). At S1316, the host network apparatus (200) performs the conditional switch to the PTM_connection to PTP_connection/PTP idle connection. At S1318, the UE (100) sends the RACH message indicating a feedback of RSSI/RSRP to the host network apparatus (200) or the UE (100) sends the normal RACH and signalling for signal conditions (e.g., idle mode measurements) to the host network apparatus (200).

FIG. 14 illustrating an example scenario (S1400) of the UE operations in a PALS network, according to the embodiments as disclosed herein. FIG. 14 depicts a variety of services e.g., localized services/contents, edge application, social networking services, television services, video streaming services, high bit rate download services, public safety services, mission critical push-to-talk (MCPTT), vehicle-to-everything (V2X) services, group communication services, IoT (Internet-of-Things) services, IPTV, augmented reality (AR) and virtual reality (VR) applications etc. are being provided to the UE (100) in the enhanced communication system incorporating the PALS network (i.e., host network) and macro network (e.g., home network).

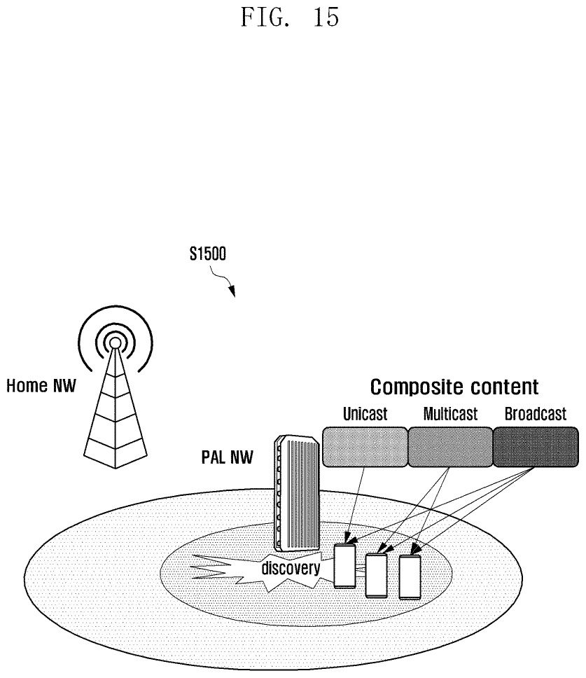

FIG. 15 illustrates an example scenario (S1500) in which contents is disseminated through plurality of delivery modes including unicast, multicast and broadcast in the PALS network, according to the embodiments as disclosed herein. Also, it depicts the service discovery mechanism by which UEs can know about the availability of the services in PALS network.

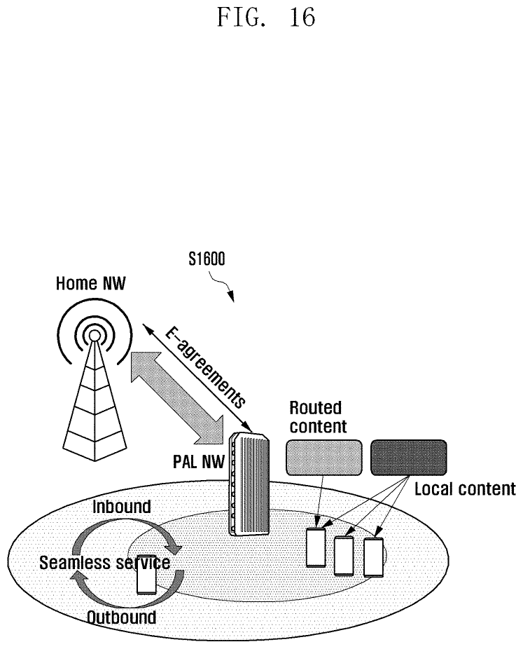

FIG. 16 illustrates the inbound and outbound service continuity across the PALS network and the home network (S1600) according to the embodiments as disclosed herein.

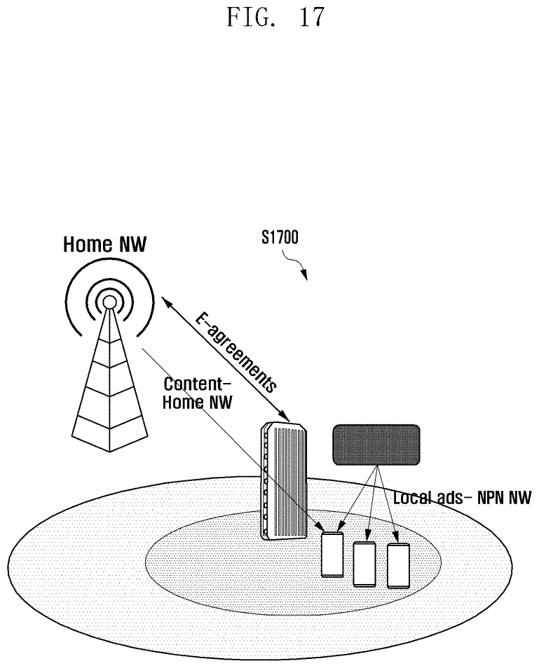

FIG. 17 illustrates the multiple contents merging in the localized contents e.g., including advertisements with local contents in the PALS network (S1700) according to the embodiments as disclosed herein.

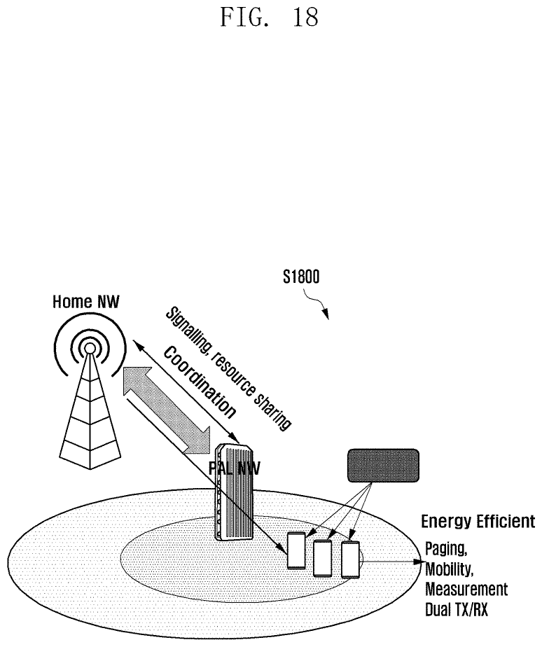

FIG. 18 illustrates energy efficient delivery mechanism (S1800) in the PALS network, wherein optimized procedures for paging, mobility, measurements etc. are performed, according to the embodiments as disclosed herein.

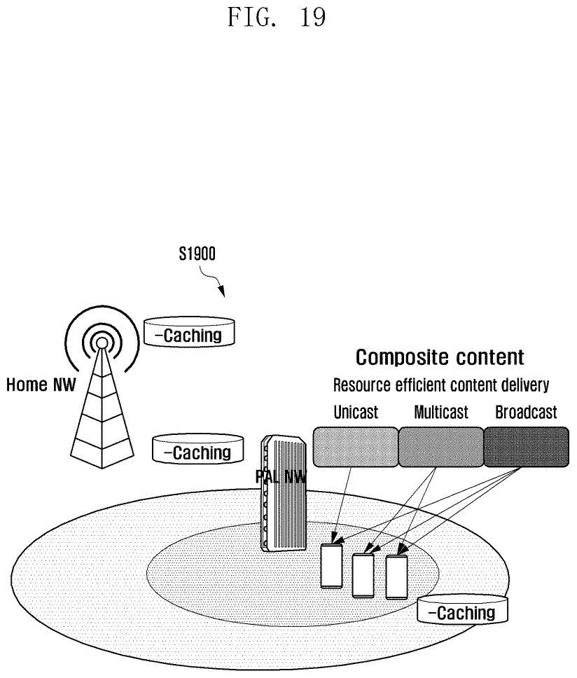

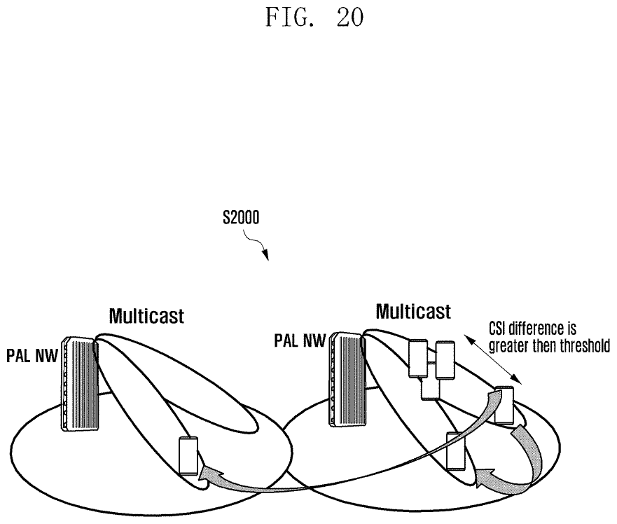

FIG. 19 and FIG. 20 illustrates (S1900 and S2000) the caching operations at the UE, PALS network and home network, according to the embodiments as disclosed herein.

Below use cases describes the local service network that provides numerous spectators with simultaneous media services in an efficient manner. As a scenario, consider a stadium that periodically hosts events that can benefit from multicast and broadcast services for the benefit of spectators. Pre-conditions are as follows:
1. Rajesh is big fan of cricket and he loves watching cricket matches in stadium. cricket matches are typically long e.g., about 7 hrs for one day matches and 3-4 hours for T20 matches. Rajesh looks forward to the variety of streaming videos/informative content for replays, scores and statistics that the organizers promise to provide to the spectator present;
2. Rajesh has his ticket and thereby the event organizers have some information about Rajesh and can provide information to Rajesh;
3. Commercial advertisements and other services in stadium e.g., related to food services etc. can be promoted via the communication services and may bring revenue generation options for host venue, host network and service providers;
4. Arrangements between the commercial advertisers and service providers in the location have been established before the event; and
5. Service flow are as follows:
6. Rajesh avidly watches a video streamed program using broadcast services provided by his home (or serving) PLMN,
7. When Rajesh enters the stadium, he obtains access to the PALS network,
8. Rajesh's broadcast service from his home (or serving) PLMN continues—with service continuity. While at the stadium, Rajesh continues to have access to the services in his home (or serving) PLMN, including multicast and broadcast services from his home network and
9. Rajesh obtains access to the services provided in the stadium. This access includes a clear directory of services available, so that Rajesh can tune to different content. Some local services are provided using multicast and broadcast. These include different views of the play (from different perspectives), continuously updated scores and statistics and commentary by professional announcers on site;
10. Both the streamed action and information may come with localized advertisement—included in the media stream as part of the content;
11. The content delivery is itself may be a service for which Rajesh will be charged. This charging may take different forms: permission to access to the content or use of the content (e.g., pay per minute of use, etc.); and
12. Since Rajesh will access streamed services for long periods of time, it is extremely important that these services can be delivered in an energy efficient manner. Otherwise, Rajesh's UE will run out of batteries long before the exciting conclusion of the match.

Post conditions are as follows:
1. Rajesh's services (including multicast and broadcast services) functioned with continuity, from before he entered the stadium, even as he accessed the local service network. While at the stadium, Rajesh still was able to receive calls and access other services of his home network;
2. He was able to access streaming and informative services at the stadium subsequent to getting access to the local service network. The cost of these services were included in the cost of admission, covered by advertising or arranged for separately specifically for the services and content that Rajesh accessed. After hours of use, he had not drained his mobile device's battery due to the excellent energy efficient delivery of service; and
3. Rajesh is impressed with the congestion free reception of services (without lags and delays) in the stadium environment. While in the stadium, Rajesh continued to use services from his home network. As he leaves the stadium, there is a seamless transition, as these services continue, using the macro network. Rajesh returns home happily;

Existing features partly or fully covering the use case functionality are as follows:
1. Support for Flexible broadcast/multicast service as per 3GPP standard specification TS 22.261;
2. The communication system (i.e., communication network) may support the UE (100) with a communication subscription roaming into a communication visited mobile network which has a roaming agreement with the UE's communication home mobile network; and
3. The communication system may enable a visited mobile network to provide support for services provided in the home network as well as provide services in the visited network. Whether a service is provided in the visited network or in the home network is determined on a service by service basis.

In 3GPP standard specification 22.261:
1. Subject to an agreement between the operators and service providers, operator policies and the regional or national regulatory requirements, the communication system may support for non-public network subscribers:
   A. Access to subscribed PLMN services via the non-public network,
   B. Seamless service continuity for subscribed PLMN services between a non-public network and a PLMN,
   C. Access to selected non-public network services via a PLMN, and
   D. Seamless service continuity for non-public network services between a non-public network and a PLMN; and
2. Service delivery and continuity of applications over unicast and multicast, as controlled by the application, as described (without naming these modes) in 3GPP standard specification 22.468 GCSE_LTE, more explicitly in 3GPP standard specification 23.468 and 3GPP standard specification 29.468. Also related are 3GPP standard specification 26.346 multicast operation on demand and northbound APIs 3GPP standard specification 26.348 (northbound application programming interface (API) for multimedia broadcast/multicast service (MBMS) at the xMB reference point).

Potential new requirements needed to support the use cases are given here:
1. [PR5.x.6-1] Subject to operator policy, communication networks providing access to localized services may support operation of downlink only broadcast/multicast over a specific geographic area for UEs registered to that network.
2. [PR5.x.6-2] The operator of a communication network providing access to localized services may support a mechanism allowing different local service providers and content providers to disseminate their services and content over broadcast/multicast transport. This mechanism may also provide a means to include diverse content in the same transmission, e.g., to include advertisements with other content, or to include multiple content in the same media delivered to the user.
3. [PR5.x.6-3] A communication network providing access to localized services may provide multicast and broadcast services in an energy efficient manner to UEs receiving this service.
4. [PR5.x.6-4] A communication network providing access to localized services may support resource efficient content delivery through multicast/broadcast and intelligent caching of contents at UEs:
   A. The intent of this requirement is to effectively achieve higher resource efficiency for service delivery.
5. [PR5.x.6-5] A communication network providing access to localized services may support a mechanism to provide low latency signalling for efficient delivery of content to the UE:
   B. Signalling may include many operations including session management and radio communication.
6. [PR5.x.6-6] Subject to operator policy, a communication network providing access to localized services may be able to prioritize specific services for local access over home routed access, even if the same service is available in both networks:
   C. This requirement differs from the text in 3GPP standard specification 22.261, 6.18 “in the event of the same service being offered by multiple operators, unless directed by the home operator's network, the UE may be prioritized to receive subscribed services from the home operator's network.” This is intended to permit low latency access to certain content and services in the PALS network.

The provided methods provide different approaches and methods for providing localized services.

In the description, interchangeably used terms are local/host/local area data network (LADN)/non-public network (PALS/NPN)/Non-3GPP/visited public land mobile network (V=PLMN)/unlicensed network to represent host network which may be smaller in coverage and is used to provide localized services. Further, the PLMN/home public land mobile network (HPLMN)/Home/Macro/Global/Public/3GPP/Licensed network is interchangeably used to represent home network which may be larger in coverage and used to provide global or HPLMN services.

In an embodiment, carrier aggregation (CA) and/or dual connectivity (DC) across two different networks i.e., host network apparatus (200) and home network apparatus (300) is employed. The UE capability information including dual/multiple Rx-Tx support/frequency bands/band combinations/CA/DC support or no support, need for gaps etc. related indication(s) is reported by the UE and/or exchanged and utilized across home/host networks. Further, the host and home network apparatuses (200 and 300) coordinate between NG-RANs of two networks for efficient scheduling, energy efficiency, radio resource sharing, measurements, discontinuous reception (DRX) operation and signalling aspects for PALS and MACRO networks while they discharge their services to the UE catered by both of them. E.g., DRX operation for the UE across PALS and Macro network can be aligned to save power consumption by, as much as possible, not be awake at separate occasions. Coordination can be achieved with UE(s) interacting with both networks and/or PALS and home network coordinating with each other to arrive at better and efficient DRX configurations for the UE(s) in their networks.

This can be further related to the UE capability e.g., single or dual/multiple RX/TX support by the UE (100). The services are accessed in parallel from PALS and home PLMN and these networks can bring in coordination e.g., scheduling for the UE (100) such that capability limited UEs can also work (e.g., UEs which are not equipped with dual/multiple Rx/Tx) or capable UEs see efficiency (e.g., UEs equipped with dual/multiple Rx/Tx). Essentially, there is enhancement for multi-network connectivity scenario for PALS.

In general, in legacy there is coordination only when access links are within same network (like carrier aggregation, dual connectivity) and not for inter-network operations for a UE. Likewise, there is no coordination available for even for dual-/multi-sim device from the respective networks. 3GPP Rel-17 multi-subscriber identity module (MUSIM) work item only addresses UE-Network (one of the two networks) interaction to indirectly bring in coordinated scheduling or gaps. The present disclosure enhances inter-network coordination across host and home networks.

Considering multi-network connectivity (e.g., stadium [PALS network] is located within in the city [Home PLMN]), wherein only a subset of services may be deployed by PALS network.

In the event of the same service being offered by multiple operators, a UE may be prioritized to receive subscribed services from either the home operator's network or host network based on catering low-latency, network load aspects, coverage reliability etc. As mentioned, at least one of the factors is involved in deciding on the prioritization of at least one of the services access from at least one of the networks and it can also be dynamic determination.

In another embodiment, at least one of the services access from host network is preferred, when the UE (100) in under coverage of PALS network.

In another embodiment, at least one of the services access from home network is preferred, when the UE (100) in under coverage of PALS network.

In another embodiment, the UE (100) decides or prioritizes or selects at least one of the services access from at least one of host network or home network. The UE selection may be based on user preference, UE capability, delivery mode available or supported, signal strength, battery status, QoS of the service being received or receivable from either network. The UE may also indicate the UE preference to the network in a message to the network.

In another embodiment, the network decides or prioritizes or selects or configures at least one of the services access from at least one of host network apparatus (200) or the home network apparatus (300). It may also be pre-specified or pre-configured.

In another embodiment, the present disclosure provides a multiple of deployments scenarios wherein:
1. PALS network and its infrastructure is owned by private or third party;
2. PALS network and its infrastructure is provided by a single operator e.g., 3GPP mobile network operator (MNO);
3. Multiple MNOs may provide the PALS network and its infrastructure in parallel e.g., stadium has coverage of PALS networks of multiple MNOs; and
4. PALS network is temporarily or permanently leased or rented by the third party or private player from the one or more MNOs.

In another embodiment, host network and home network shares at least one of the radio access network (RAN), user plane function (UPF), access and mobility function (AMF), data network (DN), network exposure function (NEF), application function (AF), or caching entity etc. Among themselves, either partially or completely. The sharing of network entity e.g., RAN could be temporary or permanent basis, dynamically shared in terms of resources, slices, services, QoS flows, configurations, users, coverage, transmission power etc. Further, networks sharing the RAN can have the mapping across the MBS services/sessions (e.g., temporary mobile group identification (TMGIs) or MBS session IDs) so as to avoid duplication of the resources used to provide the MBS services/sessions. The determining factors for sharing network entity can include network load situation, coverage requirements, power requirements, quality of service (QoS) or latency needs of the services, device capabilities, delivery modes, service level agreements etc.

In another embodiment, PALS network is composed of one or more NPNs or LADNs, which may be associated with one or more MNOs and have overlapping or disjoint coverage. NPN to NPN handover is performed when a UE moves across the boundary of one NPN to other and service continuity is ensured. In some scenarios, it is also possible for UEs to receive services from more than one NPNs together along with CA, DC employments.

In an embodiment, localized services are provided with Multicasting and/or broadcasting over host network. Further, it also includes the roaming or relaying or routing of the at least one of the multicast/broadcast services and/or unicast services originating from the home network. In another embodiment, at least one of the global services is hosted at the PALS network and provided as a localized service to the users located in the coverage of PALS network.

In an embodiment, at least one of the unicast (or multicast/broadcast) contents/services from home network are switched to multicast and/or broadcast (or unicast) delivery mode over Host/LADN network e.g., based on user/access request density for at least one of the contents/services in the host network. In another embodiment, at least one of the multicast/broadcast (or unicast) contents/services from host network are switched to unicast (or multicast/broadcast) delivery mode over home network.

In another embodiment, Localized contents (i.e., contents originated in host/LADN network) are split and delivered through multicast/broadcast and unicast delivery modes to UEs, which can integrate the contents. Target is to achieve best possible resource efficiency for a composite content delivery through multiple modes. the present disclosure, therefore, provides for a service level multi-connectivity approach. Contents can be split and/or integrated at the at least one of application layer, service layer, packet data convergence protocol (PDCP) layer and medium access control (MAC), or radio link control (RLC) layer. Delivery modes may include at least one of or a combination of at least one of point-to-multipoint (PTM), point-to-point (PTP), or unicast bearer modes.

Splitting and integration and/or mapping to the different delivery modes are determined based on at least one of user/access density request, popularity, contents nature, real or non-real time contents, common or individualized/personalized contents, reliability requirements, or network load or network policy etc. The information on the split/merge and/or delivery modes mapping are provided to the UE in the configuration signalling. The configuration signalling may be provided through broadcast signalling like at least one of system information signalling, MBS control channel (MCCH), user service description (USD), service announcement and dedicated signalling like radio resource control (RRC) signalling, MAC signalling, or non-access stratum (NAS) signalling.

In another embodiment, separate security contexts are maintained at the UE and networks (e.g., host network, home network) for the multi-connectivity paths and/or different delivery modes, e.g., multicast/broadcast and unicast modes, pertaining to the same services and/or different services. Further security context may pertain to at least one of a bearer, QoS flow, PDCP entity, delivery mode, MBS session, service, PDU session etc., or a group of one or more of them. Security context may include the encryption/decryption technique, integrity protection/verification technique, security policy, security keys or key identifiers, device key, transport key, group key, group identity, count, bearer identities, sequence number, PDU session, MBS session etc. The security contexts are provided to the UEs in dedicated signalling including RRC reconfiguration message and/or NAS signalling and/or during mobility from source cell/network to target cell/network through the handover command given by the source cell/network. Target cell/network provides the security context of the unicast/multicast/broadcast session to the source cell/network while handover preparation phase. Source and target networks may pertain to at least one of the host networks or home networks.

In another embodiment, legitimate users are authenticated and authorized to receive the services over the PALS network. Users may be given different levels of authorization (e.g., in terms of services or sessions the users can access). Authentication and authorization can be provided and taken back dynamically by the PALS network at different points of time or events e.g., when a UE enters the stadium or the UE leaves the stadium or match is finished etc.

In another embodiment, for example for the stadium scenario, services are provided which are stitched together with multicast/broadcast and unicast access e.g.:
1. Video streaming, downloads, score and statistics through downlink multicast/broadcast to spectators along with voting/likes/feedback from spectators over unicast uplink; and
2. Localized service is disseminated by host network with a combination of multicast/broadcast and unicast delivery paths/modes addressing respectively common contents and customized personalized contents which can be integrated together while “receiving” or “presenting” to user.

In another embodiment, for localized services, the present disclosure provides for dynamic usage of multicast/broadcast and unicast delivery paths together for a composite content, as and when determined by PALS network.

In another embodiment, contents/services from home network are merged with local contents at host/LADN e.g., advertisements added locally. For example, service sessions/streams/service flows/QoS flows/bearers/packets are added locally at host/LADN and a composite service/session and/or transmission is formed.

In an embodiment, it is provided for PALS network/event organisers to have e-agreement with home networks/service providers to incorporate specific advertisements (or other contents) added to their contents which are directed to subscribers in the host/PALS network. Given the mass of dense subscribers' base located within host network (e.g., stadium), event organisers would like to monetize the situation. In another embodiment, incorporation of advertising (or other contents) in localized services content is applied when services are locally provided by the event organizer.

In another embodiment, PALS network can support global (macro) service when the UE is residing in PALS network as “localized service” (either through routing or hosting it locally) and when the UE moves across, the UE may have seamless and/or lossless transition for global service for outbound. This may involve some kind of context transfer and/or data forwarding between PALS and macro network.

In another embodiment, PALS network can support global (macro) service when a UE is moves from home network into PALS network as “localized service” (either through routing or hosting it locally), the UE is provided seamless/lossless transition for global service for inbound. This may involve some kind of context transfer and/or data forwarding between PALS and macro network. Signalling or operational flow for inbound and outbound.

In another embodiment, service discovery mechanism is employed by UEs for services reception in the PALS network coverage. The services availability and/or applicable configurations are obtained by the UE at least one of the approaches including (a) on demand as and when needed by utilizing signalling such as SIB on demand, on demand MCCH and/or requesting through RRC signalling, NAS signalling and application signalling, (b) Configuration by the network for the services either broadcasted or dedicated signalling including system information signalling, MCCH, USD, service announcement and dedicated signalling like RRC signalling, MAC signalling, NAS signalling, Application signalling. The services availability and/or configuration can also be provided to the UE during the mobility and/or through the signalling utilized for handover e.g., handover request, handover acknowledgement, handover command etc.

In another embodiment, LADN is considered as a potential realization for the host network providing localized services. LADN network may differ from home network in terms of coverage (cell size/service area). However, there may be mapping between LADN service area and home network tracking area(s) (TA). Optimized home network procedures based on information about the UE availability/location within LADN network coverage e.g., paging scope, reduced measurements, mobility updates are utilized.

Further, some of the contents/services, which were also available with home network, can be also being hosted/provided by the LADN (offload scenario) i.e., this is apart from routed through host network or dual access based scenarios. In another embodiment, coordinated scheduling of services between home and LADN network is performed. Edge caching support for popular contents at LADN is provided.

In another embodiment, RAN-Edge (LADN) interactions for low latency mechanism for QoS monitoring, link status, radio information e.g., signal strength like reference signal received power (RSRP)/reference signal received quality (RSRQ)/received signal strength indicator (RSSI)/signal and interference noise ratio (SINR)/channel quality indicator (CQI)/precoding matric index (PMI), caching related assistance information, congestion, interference status, user plane path latency, level of automation needed/applied etc. are provided. For transfer of this information across the UE/RAN/Edge/LADN, low latency mechanism of at least one L1 signalling, MAC signalling like MAC control element (MAC CE), RRC signalling, NAS signalling and application signalling is used.

In another embodiment, home network services/contents are cached at host/LADN. A criterion for caching specific part or complete of the at least one of the services/contents includes low latency, popularity, high user/access request density for the services/contents.

In another embodiment, caching at the UE for at least one of the services/contents is provided to capitalize the vast storage spaces available with large number of UEs available in the dense local network. With the multicast/broadcast approach, cache building step at the UE for specific content(s) can be performed in one shot. Further, intelligently caching the contents at the UEs, which these UE may require subsequently for their own consumption and/or these UEs can further provide to the other UEs e.g., with utilizing device to device communication. Typically, non-real time contents which are highly accessed or popular and/or expected to be consumed by UEs can be selected to be cached at the UEs in advance. Selection of the UEs can also be based on at least one of the many factors including but not limited to the UE's willingness to cache, storage capacity, content access request, interested contents, battery status, link conditions, QoS or latency needs, likelihood of contents consumption.

In another embodiment, RAN-Edge (LADN) interactions for low latency mechanism for cache related signalling are provided. The cache related signalling can include but not limited to the UE's willingness to cache, storage capacity, contents access request, interested contents, battery status, link conditions, QoS or latency needs, likelihood of contents consumption etc. Signalling may include many operations including session management and radio communication.

In another embodiment, contents synchronization is provided when the UE moves across PALS and macro networks. In order to ensure service continuity with seamless and/or lossless operation, PALS and macro network synchronize their contents such that same content packet relate to same packet sequence number in both the networks and/or their nodes. Further, there may not need to maintain the transmission timings, however. To achieve content synchronization across two cells and/or nodes and/or networks, there is signalling of the context information including the current running sequence number, last acknowledged packet sequence number, missing packet sequence number, stored/buffered packet information and/or data forwarding of the packets and/or path switching across two cells and/or nodes and/or networks.

In another embodiment, the host network may be deployed as one or more cells of same local/NPN network and/or one or more local or NPN networks. This may also employ mobility (i.e., selection, reselection and handover) across the two cells and/or two local/NPN networks and incorporate seamless and/or lossless service continuity with context transferring and/or data forwarding and synchronization procedures.

In another embodiment, host network broadcasts at least one of the supported slices, grouping of slices information, on boarding information, credentials information, network identities e.g., serving or neighbour NPN/PALS network identities, cell identity, tracking area identity, LADN identity, associated HPLMN identity, support for emergency services, cell access suitability, signal strength threshold, paging configuration and parameters, paging configuration mapping with slice/service, RACH configurations and parameters e.g., RACH partitioning, RACH prioritization, RACH resources association with slices or services, two step or four-step RACH usage per service/slice, measurement parameters, cell selection/reselection parameters etc. for the UEs to select/reselect, camp and access services over the cell/network. These parameters may pertain to serving cell and/or neighbour cells of one or more NPNs. The broadcast signalling is performed by at least one of SIB-1, any other existing SIB or a new SIB. SIB reception can also be on demand. Further, the signalling can also be provided to the UE in dedicated signalling when a UE is switching from connected state to Idle or Inactive state by RRC Release message or any other RRC signalling message. Certain procedures are performed and information is conveyed using NAS signalling e.g., Slice(s) or slice-group or Service(s) subscription, access class or category assignment, NPN or PALS network registration, Tracking area update, mobility update, registration request, registration update etc.

In one embodiment, energy efficiency is achieved with paging/mobility/measurements optimizations and idle and/or inactive state service access. These optimizations pertain to the procedures belonging to at least one of the host network or home network. In another embodiment, interference reduction is targeted with more UEs in Idle and/or Inactive state for multicast/broadcast reception. Further, resource efficiency is also targeted with switching or dispersing more UEs to idle and/or inactive state e.g., when network encounters the congestion situation or the number of active connections is limited than the number of UEs which need to be catered. The decision for switching UEs across connected state and idle or inactive state can be based on one or more of the congestion status at the network, the UE preference for RRC state, or channel conditions at the UE etc.

In an embodiment, paging for home network services is optimized for host/LADN coverage e.g., limiting the page scope as long as a UE resides within host network. In another embodiment, paging from home network can be routed through host network i.e., relates to cell/service/coverage area of host network.

Paging rate is increased tremendously in dense user network deployments like PALS and this leads to more instances of false paging as a UE may not be the intended paging recipient among large number of UEs located in the PALS network. This increases power consumption for the UE significantly; as it has to decode each paging message received and then identify that it is not intended recipient. Typically, identification step involves parsing of the paging records at the higher layer and determining the paging identity, which therefore involves heavy processing steps and power cost. The present disclosure attempts to address this issue of paging operation in PALS or a dense local network, which is potentially a new problem as the paging approach, in general, is not designed considering such a scenario.

Details of approaches are now provided for paging early indication (PEI), wake-up signalling (WUS), paging sub-grouping, paging frame/paging offset (PF/Poplacement), paging scope change etc. from local network perspective.

PEI approach involves providing an early indication of the presence of the paging in the upcoming PO and when it is indicated positively, a UE can pursue decoding the PO otherwise, not. The indication can be for the group of UEs which correspond to pertinent PF/PO or this could also be for specific UE. Further, PEI can also be combined with paging sub-grouping information in which UEs are further distributed among paging sub-groups and indication e.g., a bitmap for the presence of paging for each of the specific paging sub-group can be provided. One or more paging sub-groups can be associated with the MBS or specific MBS service (e.g., a group paging or a group notification for multicast session notification like a multicast session activation notification).

WUS signalling includes an indication to indicate a UE whether it can skip the DRX on duration monitoring and continues with its connected mode DRX sleep operation or it needs to be awake and decode for allocation in the DRX on duration. WUS indicates the presence or absence of allocation of the unicast and/or MBS reception. The UE receives a wakeup signal from one of the home network apparatus and the host network apparatus with an offset before scheduling of traffic from one of the home network apparatus and the host network apparatus to leverage the UE for at least one of multicast service delivery mode allocation, the unicast service delivery mode allocation, or the broadcast service delivery mode allocation. Further, the UE monitors and receives allocation of at least one of multicast data, unicast data, or broadcast data based on determination of presence of allocation from the wakeup signal. Further, the UE performs sleep operation based on determination of absence of allocation from the wakeup signal. A separate wakeup signal can be associated with each PTM MBS services configured with different DRX configurations.

Paging-sub-grouping: In order to further address the issue of large number of UEs located in a limited geographic area like PALS network, group of UEs that pertain to specific PF/PO can be further distributed among at least one more level of sub-grouping and which sub-group(s) is paged is indicated in the PEI/WUS/paging PDCCH or DCI.

Further paging sub-grouping is determined by the network based on the service requirements e.g., latency needs, paging probability, power consumption status, slices or slice-group subscribed by a UE etc. This information is available with network and/or provided by the UE e.g., UE assistance signalling or UE subscription information provided to the network.

In general, to address large number of UEs in local dense network, paging resources need to be increased tremendously, which may not be feasible always, especially the control channel resources e.g., PDCCH/DCI are limited. The present disclosure provides mechanism to have extended/larger DCI along with the PEI/WUS/new paging PDCCH which are to be newly designed and hence, can support larger DCI e.g., more number of bits for DCI. Alternatively, the present disclosure provides approaches where DCI information is provided in EPDCCH or as part of paging PDSCH payload. With more number of DCI resources, many more number of UEs/UE groups/UE sub-groups/multiple level of UE grouping can be realized in the dense local networks.

In another embodiment, PF/PO for the specific UEs are scheduled or allocated such that it is spaced close or at the same point in time with the multicast/broadcast services scheduling so that a UE need not be awake at distinct or multiple points in time (e.g., within an idle/inactive mode DRX) and conserves power. There are several approaches which the UE can utilize to achieve this PF/PO placement e.g., the UE requested GUTI reassignment, TAU signalling with needed offset information, alternative UE_ID request with registration request or UE assistance information signalling.

In another embodiment, when a UE is located in the PALS network or LADN, paging scope for the UE is changed Tracking Area or group of tracking pertaining to the LADN from the legacy registration area for the home network. This paging area or scope is altered for the paging pertaining to the at least one of the host network services (routed, hosted, localized services) as well as at least one of the home network services since the home network is made aware about the UE being located in the LADN. For this, home network receives mobility update signalling from the UE or through host network or exchanged between host and home network.

In an embodiment, multiple paging configuration and parameters e.g., paging cycle is assigned or broadcasted to UE(s) and the multiple paging configuration and parameters are associated with different slices or group of slices, services or group of services. Effectively, PALS network employs multiple paging configuration in a service specific manner e.g., low latency services or slices or groups of them which are subscribed by UEs are associated with paging configuration such as paging cycle which are smaller in periodicity to help with low latency operations; whereas other services or slices or groups of them, which can bear higher latency, are given larger paging cycle lengths.

In an embodiment, mobility update includes IN/OUT of LADN coverage information when moving in/out of LADN coverage (unlike legacy mobility update based on home network cell/tracking area/registration area/service area). This involves triggering of the procedures e.g., tracking area update when the coverage (physical boundary, received signal strength threshold, change of identify of LADN cell/TA/service area etc.) of the LADN/host network is crossed i.e., either entered into or moved out.

In an embodiment, alternatively, the UE mobility information is exchanged between home and LADN network. LADN network receives mobility information from the UE and pass it to the home network through network/backhaul signalling. In an embodiment, LADN also maps the mobility update it received from the UE to the service area/registration of the home network and accordingly, passes to home network when it is determined relevant event for the home network to know.

The provided method reduces measurements based on static location within stadium. Reduction on neighbour cell measurements for home network is applied based on the mobility update information available from the UE and/or received signal strength of the UE and/or from presence of the UE in LADN or host network and/or need for power saving for the UE. Reduction of the measurement operations and/or reporting is applied along with altering the periodicity, time-to-trigger, hysteresis, number of cells, number of beams, number of frequencies, measurement events etc. for measurement and/or reporting.

Measurement reduction is also applied to the UE in Idle/Inactive mode where a UE is not required to report the measurement report to the network based on the location of the UE within the LADN/hot network. For this purpose, the UE can be informed on the reduction factor for measurement in the broadcast signalling or dedicated signalling e.g., RRC Release when the UE is transiting from the connected state to the idle/inactive state. Further parameters and/or thresholds for signal strengths etc. can also be specified or signalled for the UE consider when it is applying the measurement reduction.

In another embodiment, the present disclosure provides for seamless and/or lossless transition for at least one of the services across home or host networks e.g., based on coverage like mobility update or coordination between home/host networks, network load balancing etc.

In another embodiment, the present disclosure provides for transition across routed access (i.e., at least one of the home networks services through host network) and dual access (where a UE receives at least one of same or different services from both host network and home network simultaneously) for receiving home network services e.g., based on measurement, mobility, QoS, location, power consumption, etc.

In another embodiment, the present disclosure provides for approaches for RACH resources extension and/or RACH resource portioning and/or RACH resource pool and/or RACH resource prioritization and/or RACH resource allocation as per service category or slice or slice-group for the UEs located in the PALS/host network. With this method, RACH resources are either adequately made available for large number of UEs densely located in host network, which may face collision/contention and/or prioritization/differentiation is brought in for the UEs with higher priority service/slice/low latency requirements. The allocation of the RACH resources and transmissions in time-frequency are signalled by the network to the UE either through subscription phase or in connected mode dedicated signalling and/or broadcast signalling and/or pre-specified.

In another embodiment, RACH resources for the UEs in the LADN/host network are dynamically scaled and/or moderated based on the user density and/or network loading in the host network e.g., number of users may change time to time or prioritization or service requirements may also change.

In another embodiment, RACH resources and/or access class or categories are configured on basis of service or service-group or slice or slice-group for the UEs in PALS network. Thereby, separate RACH configurations can be assigned to UEs or services or slices and these configurations may include RACH prioritization, RACH resource pool, RACH resources partitioning e.g., time-frequency resources or RACH occasions, two-step or four-step RACH usage etc. Effectively, service or slice or a UE specific RACH configuration and/or operation is enabled in the PALS network.

In another embodiment, connected mode DRX configurations are configured on basis of service or service-group or slice or slice-group for the UEs in PALS network. Thereby, separate DRX configurations can be assigned to UEs or services or slices and these configurations may include on duration timer, inactivity timer, DRX cycle length, short DRX cycle, long DRX cycle, DRX retransmission timer, HARQ timers etc. Effectively, service or slice or a UE specific DRX configuration and/or operation is enabled in the PALS network.

In another embodiment, switching across PTM and PTP mode is performed for receiving multicast/broadcast contents in the PALs network by at least one of the following:
1. When the signal strength threshold is met e.g., when a UE perceives RSRP/RSRQ/SINR/RSSI/CQI/PMI below a specified/configured threshold value, it switches from PTM to PTP by itself or the UE indicates to the network for the switching and vice-versa for PTP to PTM switching;
2. Network determines to switch a UE between PTM and PTP modes on the basis of the measurement report or feedback network received from the UE e.g., RSRP/RSRQ/SINR/RSSI/CQI/PMI crosses a specified/configured threshold value;
3. Network determines to switch a UE between PTM and PTP modes on the basis of the network load, number of users subscribing/receiving or interested to receive at least one of the multicast/broadcast services, priority or preference of the UEs for delivery mode or bandwidth part (BWP); or
4. Network determines to switch a UE from PTM to PTP modes when the UE requires more HARQ retransmissions than a determined threshold for PTM group of UEs and/or requires more RLC retransmissions than a determined threshold for PTM group of UEs and/or causes a window stalling or window edge stuck for common transmission window operation of the network for multicast/broadcast transmission and/or have more BLER or lower signal strengths or different location (e.g., towards cell edge) or lower performance than a determined threshold for PTM group of UEs. Determined threshold for PTM group of UEs can be at least one of average, worst, best, or independently calculated threshold configuration/parameter by the network. The threshold configuration can be for per PTM service or a group of PTM services or for all the PTM services altogether.

In another embodiment, PALS network deploys a subset of reference signal configurations as compared to the home networks e.g., CSIRS mobility measurement and reporting configuration, DMRS reference signal types and configurations, CSIRS tracking/feedback configurations and reporting, MBS common Reference signal configurations. This is to support a large base of UEs densely located in the PALS network which are likely to be less mobile. Further, PALS network groups multiple UEs with same measurement configurations or reuse reporting from few UEs to representatively apply to larger group of UEs, in order to save on the network resources. The configuration may also be specific to service or service-group or slice or slice-group or delivery modes e.g., ultra reliable low latency communication (URLLC) services are provided different DMRS configuration than the eMBB (enhanced Massive Broad Band) services in the PALS network.

In another embodiment, MBS service in communication expected to relish beam forming mechanism, which will enhance the quality of multicast service with efficient multicast resource scheduling. In such scenario, a service or multiple multicasting service could be served by the beams of a cell or by beams of multiple cells in an area. Multicast services with beam forming are expected to have link adaptation procedure as one of the embodiment, where in, multiples UEs getting served by multicasting service in a beam of a cell may send feedback channel state information as CQI, PMI, RI to the cell for scheduling of transmission on physical resources with suitable MCS. 3D beam forming may also need the CSI information in horizontal and vertical dimension, therefore, a UE may be able to feedback CQI, PMI RI in both dimension.

Unlike unicast service; link adaptation in multicasting services is complex in nature because multicasting link is associated with multiples of UEs and allocation of physical resources and MCS are tightly associated with feedback received from multiple of UEs b the cell, those who have subscribed to the same or multiple services.

It's interesting to note that, in aforementioned scenario, allocation of resources (time, frequency, space, code) and modulation and coding (MCS) may be governed by the UE which is experiencing weakest channel condition in the beam and reporting worst CSI information.

In this scenario, following solutions are provided to overcome the issue:
1. Cell may receive CSI information from all UEs in the beam, which are served by one or multiple multicasting services by the cell and/or by beam. After receiving CSI information, Cell may detect the condition for every UE, where “difference of CSI information is greater than certain “threshold.” After identification:
   a) Cell may indicate to the detected UEs in DCI information to trigger the beam switch. and
   b) Alternatively, cell may indicate to the UE/UEs in DCI information to provide feedback of all beams, which are serving subscribed and active multicasting services by the UEs. In this case, based on the received feedback, cell may take scheduling decision and inform to UEs about suitable beam in DCI information. Afterwards, a UE can trigger beam switch on the indicated beam of the same cell or different cell which is providing the subscribed and active multicasting service.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

Although the present disclosure has been described with various embodiments, various changes and modifications may be suggested to one skilled in the art. It is intended that the present disclosure encompass such changes and modifications as fall within the scope of the appended claims.

What is claimed is:

1. A method for providing access to localized services (PALS) in a communication network, wherein the method comprises:
establishing, by a user equipment (UE), a connection with a host network apparatus of the communication network;
establishing, by the UE, a connection with a home network apparatus of the communication network;
selecting, by the UE, at least one of the home network apparatus or the host network apparatus to access, based on service prioritization at the UE, at least one of a multicast service delivery mode, a unicast service delivery mode, or a broadcast service delivery mode; and
receiving, by the UE, content disseminated from the at least one of the home network apparatus or the host network apparatus over the at least one of the multicast service delivery mode, the unicast service delivery mode, or the broadcast service delivery mode in the communication network.

2. The method of claim 1, further comprising:
receiving, by the UE, a UE capability request from the at least one of the home network apparatus or the host network apparatus; and
sending, by the UE, a UE capability response comprising capability of supporting for a multiple transmission-reception (TX-RX) to the at least one of the host network apparatus or the home network apparatus, wherein the UE supports multiple TX antennas and multiple RX antennas and operates in one of carrier aggregation mode with the host network apparatus and the home network apparatus or a dual connectivity mode with the host network apparatus and the home network apparatus.

3. The method of claim 1, wherein the selecting the at least one of the home network apparatus or the host network apparatus to access the at least one of the multicast service delivery mode, the unicast service delivery mode, or the broadcast service delivery mode based on service prioritization at the UE comprises:
determining, by the UE, a plurality of parameters associated with the home network apparatus, wherein the plurality of parameters associated with the home network apparatus comprises at least one of a home network link status, home network measurements, or a home network service availability;
determining, by the UE, a plurality of parameters associated with the host network apparatus, wherein the plurality of parameters associated with the host network apparatus comprises at least one of a host network link status, host network measurements, or a host network service availability;
prioritizing, by the UE, service from the at least one of the host network apparatus or the home network apparatus based on the plurality of parameters associated with the home network apparatus and the plurality of parameters associated with the host network apparatus; and
selecting, by the UE, the at least one of the home network apparatus or the host network apparatus to access the at least one of the multicast service delivery mode, the unicast service delivery mode, or the broadcast service delivery mode based on the service prioritization at the UE.

4. The method of claim 1, wherein the receiving the content disseminated from the at least one of the home network apparatus or the host network apparatus over the at least one of the multicast service delivery mode, the unicast service delivery mode, or the broadcast service delivery mode in the communication network comprises:
receiving, by the UE, discontinuous reception (DRX) parameters from the at least one of the home network apparatus or the host network apparatus in order to align with a connected mode DRX at the UE corresponding to the host network apparatus and a connected mode DRX at the UE corresponding to the home network apparatus, wherein the DRX parameters comprise at least one of a DRX cycle length, a DRX ON duration timer, a short DRX cycle, a long DRX cycle, a DRX retransmission timer, DRX round trip time (RTT) timers, or a DRX offset; and receiving, by the UE, the content disseminated from the at least one of the home network apparatus or the host network apparatus over the at least one of the multicast service delivery mode, the unicast service delivery mode, or the broadcast service delivery mode based on an alignment of the connected mode DRX at the UE to the host network apparatus and a connected mode DRX at the UE to the home network apparatus, or
receiving, by the UE, a caching willingness enquiry message from the host network apparatus; determining, by the UE, whether to receive and cache content from the host network apparatus based on at least one of a popularity matrix, a battery status of the UE, or a storage capacity of the UE; sending, by the UE, a caching willingness response indicating for willingness of the UE to receive and cache the content from the host network apparatus; receiving and caching, by the UE, the content from the host network apparatus over the at least one of the multicast service delivery mode, the unicast service delivery mode, or the broadcast service delivery mode; splitting, by the UE, the content received from the host network apparatus into the at least one of the multicast service delivery mode, the unicast service delivery mode, or the broadcast service delivery mode; and sending, by the UE, the content received from the host network apparatus to at least one other UE over the at least one of the multicast service delivery mode, the unicast service delivery mode, or the broadcast service delivery mode using a radio link or a side link.

5. The method of claim 1, further comprising:
determining, by the UE, misalignment of a paging occasion and multicast or broadcast service scheduling occasions;
sending, by the UE, a globally unique temporary identifier (GUTI) reassignment request to the host network apparatus, wherein the GUTI reassignment request is sent to ensure alignment of idle mode DRX cycle of the host network apparatus and the home network apparatus; and
receiving, by the UE, new paging resources information from the host network apparatus, wherein the new paging resources information comprises at least one of a paging offset or a UE identity.

6. The method of claim 1, further comprising:
receiving, by the UE, paging configuration information including paging sub-group in order to receive a paging for specific multicast or broadcast service delivery modes associated with the paging sub-group; and receiving, by the UE, a paging early indication (PEI) before a paging occasion indicating presence or absence of the paging sub-group for the UE for the specific multicast or broadcast service delivery modes associated with a subgroup; or
receiving, by the UE, a wakeup signal from the at least one of the home network apparatus or the host network apparatus with an offset before scheduling of traffic from the at least one of the home network apparatus or the host network apparatus to leverage the UE for at least one of multicast service delivery mode allocation, a unicast service delivery mode allocation, or a broadcast service delivery mode allocation; monitoring and receiving, by the UE, allocation of at least one of multicast data, unicast data, or broadcast data based on determination of presence of allocation from the wakeup signal; and performing, by the UE, a sleep operation based on a determination that allocation is absence from the wakeup signal.

7. The method of claim 1, further comprising:
performing, by the UE, a reference signal measurement when the UE is in point to multi-point in an idle mode (PTM_Idle) and subscribed for the at least one of the multicast service delivery mode, the unicast service delivery mode, or the broadcast service delivery mode;
determining, by the UE, whether the reference signal measurement meets a reference signal threshold;
sending, by the UE, a feedback comprising the reference signal measurements to the host network apparatus in response to determining that the reference signal measurement meets the reference signal threshold, wherein the feedback is sent through one of a random access channel (RACH) message, an idle mode measurement message, or a radio resource control (RRC) message;
receiving, by the UE, an RRC configuration from the host network apparatus to configure the UE in one of a point to multipoint in connected (PTM_conn) mode and a point to point connected (PTP_conn) mode;
measuring, by the UE, at least one of a beam index (BI), a channel quality indicator (CQI), a precoding matrix indicator (PMI), or a rank indicator (RI) when the UE is in one of the PTM_conn mode or the PTP_conn mode;
sending, by the UE, a channel state information (CSI) feedback to the host network apparatus; and
receiving, by the UE, a RRC configuration from the host network apparatus to reconfigure the UE to one of the PTM_conn mode, the PTP_conn mode, or the PTM_idle mode,
wherein sending the feedback comprises:
configuring, by the host network apparatus, a RACH configuration by dividing RACH resources into subgroups, wherein physical resources in each of the subgroups is used to send a feedback for a specific multicast and broadcast service delivery modes; and
sending, by the UE, the feedback using the RACH message.

8. The method of claim 1, further comprising:
determining, by the UE, whether to transit to one of an idle mode or an inactive mode based on at least one of a power saving need of the UE or a link condition between the UE and the host network apparatus and signalling, by the UE, an indication or a preference to the host network apparatus for the transition to the idle mode or the inactive mode; or
receiving, by the UE, signalling from the host network apparatus for a configuration and transition of the UE to one of an idle mode or an inactive mode; transitioning, by the UE, to one of the idle mode or the inactive mode; and continuing, by the UE, reception of contents from the host network apparatus in one of the idle mode or the inactive mode.

9. A method for providing access to localized services (PALS) in a communication network, wherein the method comprises:
establishing, by a host network apparatus of the communication network, a communication connection with at least one user equipment (UE) from a plurality of UEs in the communication network;
enabling, by the host network apparatus, for allowing different local service providers and content providers in the communication network to disseminate services and content over at least one of broadcast, multicast, or unicast transport to the at least one UE in the communication network; and
disseminating, by the host network apparatus, the content to the at least one UE over at least one of a multicast service delivery mode, a unicast service delivery mode, or a broadcast service delivery mode.

10. The method of claim 9, further comprising:
receiving, by the host network apparatus, a plurality of requests from the plurality of UEs;
determining, by the host network apparatus, whether the plurality of requests is greater than, less than, or equal to a user request density threshold; and
performing, by the host network apparatus, at least one of:
configuring one of the multicast service delivery mode or the broadcast service delivery mode to disseminate the content to the at least one UE in response to determining that the plurality of requests is greater than or equal to the user request density threshold, and
configuring the unicast service delivery mode to disseminate the content to the at least one UE in response to determining that the plurality of requests is less than the user request density threshold.

11. The method of claim 9, wherein the disseminating the content to the at least one UE over the at least one of the multicast service delivery mode, the unicast service delivery mode, or the broadcast service delivery mode comprises:
receiving, by the host network apparatus, home network content to be shared to the at least one UE from the home network apparatus;
splitting, by the host network apparatus, the home network content into the at least one of the multicast service delivery mode, the unicast service delivery mode, or the broadcast service delivery mode; and
disseminating, by the host network apparatus, the home network content over the at least one of the multicast service delivery mode, the unicast service delivery mode, or the broadcast service delivery mode to the at least one UE,
wherein disseminating the content to the at least one UE over the at least one of the multicast service delivery mode, the unicast service delivery mode, or the broadcast service delivery mode comprises:
receiving, by the host network apparatus, the home network content to be shared to the at least one UE from the home network apparatus;
receiving, by the host network apparatus, home network content to be routed by the host network; stitching, by the host network apparatus, the home network content with host network content; and
disseminating, by the host network apparatus, the home network content stitched with the host network content over the at least one of the multicast service delivery mode, the unicast service delivery mode, or the broadcast service delivery mode to the at least one UE.

12. The method of claim 9, wherein the disseminating the content to the at least one UE over the at least one of the multicast service delivery mode, the unicast service delivery mode, or the broadcast service delivery mode comprises:
caching, by the host network apparatus, the content based on a popularity matrix;
sending, by the host network apparatus, a caching willingness enquiry message to the at least one UE;
receiving, by the host network apparatus, a caching willingness response indicating willingness of the UE to receive and cache the content from the host network apparatus;
splitting, by the host network apparatus, the content into the at least one of the multicast service delivery mode, the unicast service delivery mode, or the broadcast service delivery mode; and
disseminating, by the host network apparatus, home network content over the at least one of the multicast service delivery mode, the unicast service delivery mode, or the broadcast service delivery mode to the at least one UE.

13. The method of claim 9, further comprising:
receiving, by the host network apparatus, a globally unique temporary identifier (GUTI) reassignment request from the at least one UE, wherein the GUTI reassignment request is sent to ensure alignment of idle mode discontinuous reception (DRX) cycle of the host network apparatus and a home network apparatus;
receiving, by the host network apparatus, home network paging resources information from the home network apparatus; and
sending, by the host network apparatus, the home network paging resources information to the at least one UE to receive the content over the at least one of the multicast service delivery mode, the unicast service delivery mode, or the broadcast service delivery mode to align the idle mode DRX cycle of the host network apparatus and the home network apparatus, wherein the home network paging resources information comprises at least one of a paging offset or a UE identity.

14. The method of claim 9, further comprising:
dividing, by the host network apparatus, paging resources into subgroups;
sending, by the host network apparatus, paging configuration information to the at least one UE, wherein the paging configuration information includes paging sub-group in order to receive a paging for specific multicast or broadcast service delivery modes associated with the paging sub-group; and
sending, by the host network apparatus, a paging early indication (PEI) to the at least one UE before a paging occasion indicating presence or absence of the paging sub-group for the UE for specific multicast or broadcast service delivery modes associated with the subgroups.

15. The method of claim 9, further comprising:
sending, by the host network apparatus, a wakeup signal to the at least one UE with an offset before scheduling of traffic from the at least one of a home network apparatus or the host network apparatus to leverage the UE for at least one of a multicast service delivery mode allocation, a unicast service delivery mode allocation, or a broadcast service delivery mode allocation;
scheduling, by the host network apparatus, at least one of multicast data, unicast data, or broadcast data to the UE when presence of allocation is indicated in the wakeup signal to the UE; and
skipping, by the host network apparatus, scheduling at least one of multicast data, unicast data, or broadcast data to the UE when absence of allocation is indicated in the wakeup signal to the UE.

16. The method of claim 9, further comprising:
receiving, by the host network apparatus, a feedback comprising reference signal measurements from the at least one UE, wherein the feedback is received through at least one of a random access channel (RACH) message, an idle mode measurement message, or a radio resource control (RRC) message;
switching, by the host network apparatus, from point to multipoint idle (PTM_idle) to one of point to multipoint connected (PTM_conn) mode and a point to point connected (PTP_conn) mode;
sending, by the host network apparatus, an RRC configuration from the host network apparatus to configure the UE in one of the PTM_conn mode and the PTP_conn mode;
receiving, by the host network apparatus, a channel state information (CSI) feedback from the at least one UE;
switching, by the host network apparatus, from one of the PTM_conn mode or the PTP_conn mode to one of the PTM_conn mode, the PTP_conn mode, or a PTM_idle mode; and
sending, by the host network apparatus, a RRC configuration from the host network apparatus to reconfigure the UE to one of the PTM_conn mode, the PTP_conn mode, or the PTM_idle mode.

17. The method of claim 9, wherein the method further comprises:
receiving, by the host network apparatus, a CSI feedback from the plurality of UEs;
determining, by the host network apparatus, whether the CSI feedback received from each UE of the plurality of UEs meets a weakest UE threshold; and
performing, by the host network apparatus, one of:
assigning physical resource allocation for multicast per beam or per cell based on the CSI feedback shared by a weakest UE of the plurality of UEs and resource scheduling and assignment for multicast and unicast resources, or
triggering a beam switch operation or a handover to the UE reported with min CQI, scheduling resource for multicast and unicast resources, and
sending a DCI-multicast/unicast resource allocation to inform for the beam switch operation to the at least one UE of the plurality of UEs.

18. The method of claim 9, further comprising:
determining, by the host network apparatus, whether to transit the at least one UE to one of an idle mode or an inactive mode based on at least one of a congestion status, a resource efficiency level, a link condition between the at least one UE and a host network entity, UE's request for preferred RRC state, or power saving need of the at least one UE;
signalling, by the host network apparatus, to the at least one UE for a configuration and transition of the at least one UE to one of the idle mode or the inactive mode; and
continuing, by the host network apparatus, providing contents to the at least one UE in one of the idle mode or the inactive mode.

19. A user equipment (UE) for providing access to localized services (PALS) in a communication network, wherein the UE comprises:
memory;
a processor; and
a PALS controller, communicatively coupled to the memory and the processor, configured to:
establish a communication connection with a host network apparatus of the communication network;
establish a communication connection with a home network apparatus of the communication network;
select at least one of the home network apparatus or the host network apparatus to access, based on service prioritization at the UE, at least one of a multicast service delivery mode, a unicast service delivery mode, or a broadcast service delivery mode; and
receive content disseminated from the at least one of the home network apparatus and the host network apparatus over the at least one of the multicast service delivery mode, the unicast service delivery mode, or the broadcast service delivery mode in the communication network.

20. A host network apparatus for providing access to localized services (PALS) in a communication network, wherein the host network apparatus comprises:
memory;
a processor; and
a PALS controller, communicatively coupled to the memory and the processor, configured to:
establish a communication connection with at least one user equipment (UE) from a plurality of UEs in the communication network;
enable for allowing different local service providers and content providers in the communication network to disseminate services and content over at least one of broadcast, multicast, or unicast transport to the at least one UE in the communication network; and
disseminate the content to the at least one UE over at least one of a multicast service delivery mode, a unicast service delivery mode, or a broadcast service delivery mode.
